(19) United States
(12) Patent Application Publication
(10) Pub. No.: US 2024/0317177 A1
(43) Pub. Date: Sep. 26, 2024

(54) VEHICLE CONTROL DEVICE, VEHICLE CONTROL METHOD, AND NON-TRANSITORY COMPUTER-READABLE STORAGE MEDIUM

(71) Applicant: DENSO CORPORATION, Kariya-city (JP)

(72) Inventors: Takayuki MATSUMOTO, Kariya-city (JP); Nobuyasu Okabe, Kariya-city (JP)

(21) Appl. No.: 18/732,856

(22) Filed: Jun. 4, 2024

Related U.S. Application Data
(63) Continuation of application No. PCT/JP2022/043591, filed on Nov. 25, 2022.

(30) Foreign Application Priority Data
Dec. 6, 2021 (JP) 2021-198051

(51) Int. Cl. B60R 25/24; B60R 25/20; H04Q 9/00

(52) U.S. Cl. CPC B60R 25/24; B60R 25/2009; H04Q 9/00

(57) ABSTRACT

A smart ECU switches on a traveling power supply on condition that a portable device of a user is present in a start area set in a vehicle. The smart ECU normally determines whether the portable device is present in the start area based on reception strength of a signal from the portable device at a first communication device that is a specific BLE communication device disposed in the vehicle. However, in a case where a failure is detected in the first communication device, the smart ECU determines that the portable device is present in the start area when reception strength at a second communication device, which is another BLE communication device set in advance as a substitute device, is equal to or greater than a predetermined value.

### CROSS REFERENCE TO RELATED APPLICATION

The present application is a continuation application of International Patent Application No. PCT/JP2022/043591 filed on Nov. 25, 2022, which designated the U.S. and claims the benefit of priority from Japanese Patent Application No. 2021-198051 filed on Dec. 6, 2021. The entire disclosures of all of the above applications are incorporated herein by reference.

### TECHNICAL FIELD

The present disclosure relates to a vehicle control device, a vehicle control method, and a non-transitory computer-readable storage medium.

### BACKGROUND

Conventionally, a vehicle is equipped with an in-vehicle device that is configured to communicate with a portable device held by a user.

### SUMMARY

According to an aspect of the present disclosure, a vehicle control device is to be connected to a plurality of communication devices that are configured to perform radio communication with a portable device carried by a user of a vehicle.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating an overall configuration of a vehicle electronic key system;

FIG. 2 is a block diagram illustrating a configuration of a BLE communication device;

FIG. 3 is a diagram illustrating an example of a place where the BLE communication device is mounted;

FIG. 4 is a functional block diagram of a smart ECU;

FIG. 5 is a flowchart of an unlocking control process;

FIG. 6 is a flowchart of an operating mode control process;

FIG. 7 is a flowchart illustrating a start control process in a normal mode;

FIG. 8 is a flowchart illustrating the start control process in a temporary mode;

FIG. 9 is a graph illustrating a relationship between a locking and unlocking area determination value and a temporary start area determination value;

FIG. 10 is a conceptual diagram illustrating a relationship between a locking and unlocking area and a temporary threshold excess area;

FIG. 11 is a flowchart illustrating an example of a sequence of applying the temporary mode based on a user operation on a vehicle;

FIG. 12 is a flowchart illustrating an example of a sequence in a case where a user is notified of a remaining number that a traveling power supply can be set to ON in the temporary mode;

FIG. 13 is a flowchart illustrating an operation example of the smart ECU that performs different processes according to the remaining number that the traveling power supply can be set to ON in the temporary mode;

FIG. 14 is a diagram illustrating a modification of a system configuration;

FIG. 15 is a diagram illustrating a modification of the system configuration; and

FIG. 16 is a diagram illustrating a modification of the system configuration.

### DETAILED DESCRIPTION

Hereinafter, examples of the present disclosure will be described.

According to an example of the present disclosure, in a case where it is determined that a portable device is present in a vehicle cabin based on reception strength of a signal from the portable device measured at multiple in-vehicle antennas, an in-vehicle device starts an engine using pressing of a start button provided in the vehicle as a trigger.

According to an example of the present disclosure, an in-vehicle device uses a control mode of reducing a communication area of a vehicle interior antenna when a failure of a vehicle exterior antenna is detected, in order to restrict an erroneous determination that the portable device is present in the vehicle cabin although the portable device is actually present outside the vehicle cabin.

A situation is assumable where an indoor unit which is a communication device corresponding to the vehicle interior antenna fails. In a system in which the position of a portable device is determined based on a communication state with the portable device, if an in-cabin unit fails, it may be difficult to determine whether the portable device is present in a start area in a vehicle cabin. The start area herein refers to an area for permitting the start of a driving source for causing the vehicle to travel, such as an engine or a motor. In one aspect, the start area may be regarded as an area for permitting a traveling power supply to be turned on.

When it becomes impossible to determine whether the portable device is present in the start area due to a failure of a specific in-cabin unit, a user cannot drive the vehicle in the same procedure as usual. Here, the same procedure as usual is a procedure in a case where the in-cabin unit is operating normally, and indicates, for example, pressing of a start button in a state where the brake pedal is depressed. The specific in-cabin unit refers to a communication device for start determination, that is, an in-cabin unit used to determine whether the portable device is present in the start area. When it is impossible to determine whether the portable device is present in the start area due to a failure of the specific in-cabin unit, the user may need to use backup means such as a mechanical key in order to turn on the traveling power supply. As a result, the convenience for the user may be reduced.

According to an example of the present disclosure, a first vehicle control device disclosed herein is to be connected to a plurality of communication devices that are configured to perform radio communication with a portable device carried by a user of a vehicle by using a same communication band. The plurality of communication devices include a first communication device that is a specific one of the communication devices installed in the vehicle and a second communication device that is a specific one of the communication devices other than the first communication device. The vehicle control device comprises:
a communication control unit configured to control the plurality of communication devices and acquire data indicating a reception state of a radio signal from the portable device at the plurality of communication devices;
a diagnostic unit configured to detect a failure of the first communication device based on an input signal from the first communication device or based on a fact that no signal is received from the first communication device; and
a vehicle control unit configured to switch a traveling power supply between on and off.

When the diagnostic unit detects no failure of the first communication device, the vehicle control unit is configured to permit the traveling power supply to be switched on based on a fact that data indicating a reception state of a signal from the portable device at the first communication device satisfies a specific normal area determination condition. When the diagnostic unit detects a failure of the first communication device, the vehicle control unit is configured to permit the traveling power supply to be switched on based on a fact that data indicating the reception state of the signal from the portable device at the second communication device satisfies a predetermined temporary area determination condition different from the normal area determination condition.

According to the above vehicle control device, even in a case where a failure occurs in the first communication device, when the second communication device is operating normally, the user can set the traveling power supply to ON in the same operation procedure as usual. That is, even when a failure occurs in the communication device for determining whether the portable device is present in the start area, it is possible to reduce the possibility that the convenience for the user is impaired. The same applies to a vehicle control method and a control program.

According to an example of the present disclosure, a second vehicle control device of the present disclosure is to be connected to a plurality of communication devices that are configured to perform radio communication with a portable device carried by a user of a vehicle by using a same communication band. The plurality of communication devices include a first communication device that is a specific one of the communication devices installed in the vehicle and a second communication device that is a specific one of the communication devices other than the first communication device. The vehicle control device comprises:
a communication control unit configured to control the plurality of communication devices and acquire data indicating a reception state of a radio signal from the portable device at the plurality of communication devices;
a diagnostic unit configured to detect a failure of the first communication device based on an input signal from the first communication device or based on a fact that no signal is received from the first communication device; and
a position determination unit configured to determine a position of the portable device with respect to the vehicle based on a reception state from the portable device at the first communication device or the second communication device.

In a case where the diagnostic unit detects no failure of the first communication device, the position determination unit is configured to determine that the portable device is present in a start area in a vehicle cabin when data indicating a reception state of a signal from the portable device at the first communication device satisfies a specific normal area determination condition. In a case where the diagnostic unit detects a failure of the first communication device, the position determination unit is configured to determine that the portable device is present in the start area when data indicating the reception state of the signal from the portable device at the second communication device satisfies a predetermined temporary area determination condition different from the normal area determination condition.

According to an example of the present disclosure, a vehicle control method disclosed herein is for switching on a traveling power supply of a vehicle, which is to be executed by at least one processor. The vehicle control method comprises:
acquiring, from a first communication device configured to perform radio communication with a portable device carried by a user of the vehicle, data indicating a reception state of a signal from the portable device;
acquiring, from a second communication device, data indicating the reception state of the signal from the portable device, the second communication device being arranged at a position different from the first communication device and being configured to perform radio communication using a communication band same as the first communication device;
detecting a failure of the first communication device based on an input signal from the first communication device or based on a fact that no signal is received from the first communication device;
permitting the traveling power supply to be switched on based on a fact that the reception state of the signal from the portable device at the first communication device satisfies a specific normal area determination condition when no failure of the first communication device is detected; and
permitting the traveling power supply to be switched on based on a fact that the reception state of the signal from the portable device at the second communication device satisfies a predetermined temporary area determination condition different from the normal area determination condition when a failure of the first communication device is detected.

According to an example of the present disclosure, a control program disclosed herein includes instructions for causing at least one processor to:
acquire, from a first communication device configured to perform radio communication with a portable device carried by a user of a vehicle, data indicating a reception state of a signal from the portable device;
acquire, from a second communication device, data indicating the reception state of the signal from the portable device, the second communication device being arranged at a position different from the first communication device and being configured to perform radio communication using a communication band same as the first communication device;
detect a failure of the first communication device based on an input signal from the first communication device or based on a fact that no signal is received from the first communication device;
permit the traveling power supply to be switched on based on a fact that the reception state of the signal from the portable device at the first communication device satisfies a specific normal area determination condition when no failure of the first communication device is detected; and
permit the traveling power supply to be switched on based on a fact that the reception state of the signal from the portable device at the second communication device satisfies a predetermined temporary area determination condition different from the normal area determination condition when a failure of the first communication device is detected.

The reference signs in parentheses described in the claims indicate a correspondence relationship with the specific means described in the embodiment to be described later as one mode, and do not limit the technical scope of the present disclosure.

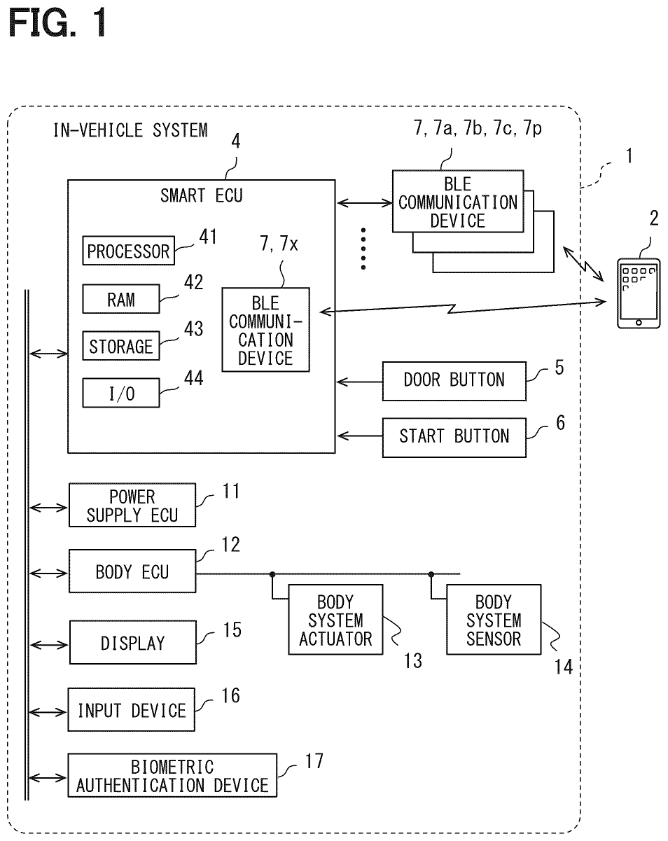

Hereinafter, embodiments of the present disclosure will be described with reference to the drawings. FIG. 1 is a diagram illustrating an example of a schematic configuration of a vehicle electronic key system. As illustrated in FIG. 1, the vehicle electronic key system includes an in-vehicle system 1 and a portable device 2. The in-vehicle system 1 is a system mounted on a vehicle Hv. The portable device 2 is a device carried by a user of the vehicle Hv. Multiple portable devices 2 may be present.

### Introduction

The vehicle Hv described below is a four-wheeled automobile owned by an individual as an example. The user of the vehicle Hv refers to an owner, a family of the owner, or the like. The vehicle Hv may be a company vehicle owned by a company organization or an official vehicle owned by a public institution. When the vehicle Hv is a company vehicle or an official vehicle, the user may be a person belonging to an organization that manages the vehicle Hv. The vehicle Hv may be a vehicle provided for a rental service (so-called rental car) or a vehicle provided for a car-sharing service (so-called shared car). When the vehicle Hv is a vehicle provided for a service, the user may be a person who has made a contract for use of the service and has an authority to temporarily use the vehicle Hv based on a use reservation of the service or the like.

The vehicle Hv is, for example, an engine vehicle. The engine vehicle refers to a vehicle including only an engine as a driving source. The engine vehicle also includes a diesel vehicle. Alternatively, the vehicle Hv may be an electric motor vehicle. The concept of the electric motor vehicle includes a hybrid vehicle and a fuel cell vehicle in addition to an electric vehicle. The electric vehicle is a vehicle including only a motor as a driving source. The hybrid vehicle is a vehicle including an engine and a motor as power sources. The hybrid vehicle includes a plug-in hybrid vehicle. The vehicle Hv may be a vehicle provided with a driver's seat door, and can be mounted on various vehicles capable of traveling on a road, such as a trailer, a tank lorry, and an open car.

The vehicle Hv is a vehicle provided with a driver's seat on the right side. Alternatively, the vehicle Hv may be a vehicle provided with a driver's seat on the left side. Front-rear, left-right, and up-down directions described below are defined based on the vehicle Hv when there is no annotation regarding a reference direction (that is, basically). Each of the various flowcharts shown in the present disclosure is an example, and the number of steps constituting the flowchart and the execution order of the process can be appropriately changed. In addition, the following description can be appropriately modified so as to conform to the regulation and the conventional practice of the region where the vehicle Hv is used.

### Overview

Both the in-vehicle system 1 and the portable device 2 are configured to be able to perform short-range communication. Here, the short-range communication refers to communication conforming to a predetermined short-range wireless communication standard in which a substantial communicable distance is, for example, about 5 m to 30 m and a maximum communicable distance is about 100 m. As the standard of the short-range communication, for example, Bluetooth (registered trademark), Wi-Fi (registered trademark), or the like can be adopted. The Bluetooth standard may be Bluetooth Classic or Bluetooth Low Energy (BLE). As the Wi-Fi standard, various standards such as IEEE 802.11n, IEEE 802.11ac, and IEEE 802.11ax (so-called Wi-Fi 6) can be adopted. The IEEE (registered trademark) is an abbreviation for Institute of Electrical and Electronics Engineers. In addition, as a communication method between the in-vehicle system 1 and the portable device 2, in other words, as a short-range communication method, Ultra Wide Band-Impulse Radio (UWB-IR) may be adopted. Further, the in-vehicle system 1 and the portable device 2 may be configured to be able to perform wireless communication using radio waves in a low frequency (LF) band such as 125 kHz or 134 KHz.

In the present embodiment, an operation of each unit will be described by taking, as an example, a case where the in-vehicle system 1 and the portable device 2 are configured to be able to perform wireless communication conforming to the BLE standard (hereinafter, BLE communication). The BLE communication in the following description can be replaced with short-range communication. Details of a communication sequence, such as communication connection and start of encrypted communication, are implemented according to the BLE standard.

Hereinafter, a case where the in-vehicle system 1 is set to act as a master in communication with the portable device 2 and the portable device 2 is set to act as a slave will be described. The in-vehicle system 1 establishes communication connection with the portable device 2 by receiving an advertisement signal from the portable device 2, and detects the presence of the portable device 2 (and thus the user) around the in-vehicle system 1. The advertisement signal is a signal for notifying (that is, advertising) the presence of the portable device 2 to another device. Alternatively, the portable device 2 may be set to operate as a master in the communication with the in-vehicle system 1.

### Regarding Portable Device 2

The portable device 2 is a portable and general-purpose information processing terminal having a BLE communication function. As the portable device 2, various communication terminals such as a smartphone and a wearable device can be adopted. The wearable device is a device used by being worn on the body of the user, and various shapes such as a wristband type, a wristwatch type, a ring type, a glasses type, and an earphone type can be adopted. The portable device 2 according to the present disclosure may be implemented by being divided into a host such as a smartphone and a wearable device.

The portable device 2 includes a display, a BLE communication module, and a device control unit. The display is, for example, a liquid crystal display or an organic EL display. The display displays an image corresponding to an input signal from the device control unit. The BLE communication module is a communication module for performing BLE communication.

The device control unit executes various arithmetic processes. The device control unit is configured as a computer including, for example, a processor, a random access memory (RAM), and a storage. The device control unit causes the BLE communication module to transmit an advertisement signal at a predetermined transmission interval. The BLE communication module performs a communication connection process with the in-vehicle system 1 based on reception of a connection request from the in-vehicle system 1.

The portable device 2 functions as an electronic key of the vehicle Hv using predetermined key information. The key information is data used in an authentication process described later. The key information is data for certifying that the person who attempts to access the vehicle Hv is the user, that is, the validity of the person who attempts to access the vehicle Hv. The key information can be called an authentication key, an encryption key, or a key code. The key information can be, for example, a character string (value) encrypted by inputting a password set by the user into a predetermined hash function. The key information may be generated based on a device ID. The device ID is an identification number assigned to each portable device 2.

The portable device 2 performs the authentication process by wireless communication based on establishment of the communication connection with the in-vehicle system 1. For example, when the BLE communication module receives a challenge code, the device control unit generates a response code using a predetermined procedure/function based on the challenge code and the key information. Then, the device control unit returns a response signal, which is a radio signal including the response code, to the in-vehicle system 1 in cooperation with the BLE communication module.

The portable device 2 may be a smart key that is a dedicated device serving as an electronic key of the vehicle Hv. The smart key is a device that is transferred to the owner together with the vehicle Hv when the vehicle Hv is purchased. The smart key can be regarded as one of accessories of the vehicle Hv. The smart key may have various shapes such as a flat rectangular parallelepiped shape, a flat elliptical shape (so-called fob type), and a card shape. The smart key may be referred to as a vehicular portable device, a key fob, a key card, an access key, or the like.

### Configuration of In-Vehicle System 1

Here, a configuration and an operation of the in-vehicle system 1 will be described. As illustrated in FIG. 1, the in-vehicle system 1 includes a smart ECU 4, multiple door buttons 5, a start button 6, and multiple BLE communication devices 7. The in-vehicle system 1 includes a power supply ECU 11, a body ECU 12, a body system actuator 13, a body system sensor 14, a display 15, an input device 16, and a biometric authentication device 17. The ECU in the member name is an abbreviation for Electronic Control Unit and means an electronic control unit.

The smart ECU 4 is connected to the door button 5, the start button 6, and the BLE communication device 7 by dedicated signal lines. The smart ECU 4 is connected to the power supply ECU 11, the body ECU 12, and the like via an in-vehicle network Nw so as to be able to communicate with each other. The in-vehicle network Nw is a communication network constructed in the vehicle Hv. As a standard of the in-vehicle network Nw, various standards can be adopted. The connection mode of the devices illustrated in FIG. 1 is an example, and the specific connection mode of the devices can be appropriately changed.

The smart ECU 4 is an ECU that determines a device position with respect to the vehicle Hv in cooperation with the BLE communication device 7 or the like and performs vehicle control according to a determination result of the device position. The device position in the present disclosure means a position of the portable device 2. The smart ECU 4 corresponds to a vehicle control device. Since the portable device 2 corresponds to the user, determining the device position corresponds to determining the position of the user. The smart ECU 4 is disposed in an instrument panel. The smart ECU 4 may be attached to an in-cabin side surface of a right or left C pillar. The C pillar refers to the third pillar from the front among pillars of the vehicle Hv.

The smart ECU 4 is implemented using a computer. That is, the smart ECU 4 includes a processor 41, a RAM 42, a storage 43, an I/O 44, and a bus line connecting these components. The smart ECU 4 of the present embodiment includes one BLE communication device 7 in a housing thereof.

The processor 41 is hardware (in other words, an arithmetic core) for arithmetic processing coordinated with the random access memory (RAM) 42. The processor 41 is, for example, a central processing unit (CPU). The processor 41 executes various types of processing for implementing a function of each functional unit described later, by accessing the RAM 42. The RAM 42 is a volatile storage medium. The storage 43 includes a nonvolatile storage medium such as a flash memory. The storage 43 stores a control program executed by the processor 41. The execution of the control program by the processor 41 corresponds to execution of a vehicle control method corresponding to the control program. The I/O 44 is a circuit module for communicating with another device.

In the storage 43, the device ID of each portable device 2 is registered. The storage 43 stores communication device setting data indicating a mounting position of each BLE communication device 7 in the vehicle Hv. The mounting position of each BLE communication device 7 may be expressed as, for example, a point on a vehicle coordinate system that is a two-dimensional coordinate system having any position of the vehicle Hv as a center and parallel to both a width direction and a front-rear direction of the vehicle Hv. An X-axis forming the vehicle coordinate system can be set parallel to the vehicle width direction, and a Y-axis can be set parallel to the front-rear direction of the vehicle. As the center of the coordinate system, for example, any position such as a center of a vehicle body or the mounting position of the smart ECU 4 can be adopted. Details of the smart ECU 4 will be described later.

The door button 5 is a switch for the user to unlock and lock a door of the vehicle Hv. The door button 5 is provided at an outer door handle provided on each door. The outer door handle refers to a grip member provided on an outer side surface of the door for opening and closing the door. When being pressed by the user, the door button 5 outputs an electric signal indicating the fact to the smart ECU 4. A touch sensor may be adopted as a configuration for receiving at least one of an unlocking instruction and a locking instruction from the user. The touch sensor may be provided at the outer door handle instead of the door button 5 or together with the door button 5.

The start button 6 is a push switch for the user to switch on/off the traveling power supply. The traveling power supply is a power supply for the vehicle Hv to travel, and indicates an ignition power supply when the vehicle is an engine vehicle. When the vehicle Hv is an electric vehicle or a hybrid vehicle, the traveling power supply indicates a system main relay. The start button 6 can be interpreted as a switch for starting a driving source (for example, an engine). When a push operation is performed by the user, the start button 6 outputs an electric signal indicating the fact to the smart ECU 4.

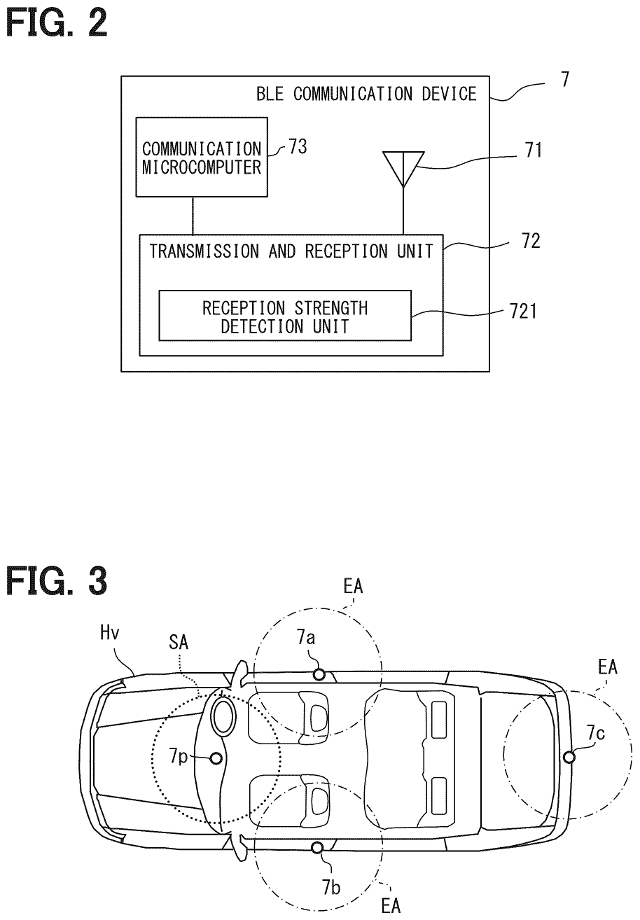

The BLE communication device 7 is a communication module for performing wireless communication with the portable device 2 according to the BLE standard. As illustrated in FIG. 2, each BLE communication device 7 includes an antenna 71, a transmission and reception unit 72, and a communication microcomputer 73. The antenna 71 is a metal body for transmitting and receiving radio waves in a frequency band used for BLE communication, that is, a 2.4 GHz band. The antenna 71 is electrically connected to the transmission and reception unit 72. The antenna 71 may be an array antenna formed by arranging multiple antenna elements side by side.

The transmission and reception unit 72 demodulates a signal received by the antenna 71 and provides the demodulated signal to the communication microcomputer 73. The transmission and reception unit 72 modulates, via the communication microcomputer 73, a signal received from the smart ECU 4, outputs the modulated signal to the antenna 71, and radiates the modulated signal as a radio wave. The transmission and reception unit 72 is connected to the communication microcomputer 73 so as to be able to communicate with each other. The transmission and reception unit 72 includes a reception strength detection unit 721 in addition to a modulator-demodulator circuit. The reception strength detection unit 721 sequentially detects the strength of signals received by the antenna 71. A signal indicating the reception strength detected by the reception strength detection unit 721 or a measurement value thereof may be referred to as a received signal strength indicator/indication (RSSI). The reception strength detected by the reception strength detection unit 721 is output to the communication microcomputer 73 together with a device ID indicating a transmission source of the received signal and frequency information of the received signal.

The communication microcomputer 73 is a microcomputer that controls data exchange with the smart ECU 4. The communication microcomputer 73 is implemented using a CPU, a RAM, a read only memory (ROM), and the like. The communication microcomputer 73 provides reception data received from the transmission and reception unit 72 to the smart ECU 4 sequentially or based on a request from the smart ECU 4. The communication microcomputer 73 outputs, based on a request from the smart ECU 4 or spontaneously, data indicating the reception strength detected by the reception strength detection unit 721 to the smart ECU 4.

Multiple BLE communication devices 7 are provided in the vehicle Hv. As an example, as illustrated in FIG. 3, the in-vehicle system 1 of the present embodiment includes BLE communication devices 7a, 7b, 7c, 7p, and 7x as the BLE communication device 7. The BLE communication device 7x is built in the smart ECU 4, while the other BLE communication devices 7 are disposed outside the smart ECU 4. The BLE communication devices 7 provided outside the smart ECU 4 are communicably connected to the smart ECU 4 via a dedicated communication line or the in-vehicle network Nw.

Each BLE communication device 7 operates based on a control signal from the smart ECU 4. Each BLE communication device 7 provides, to the smart ECU 4, reception data and data related to a reception state of a signal from the portable device 2. In the present disclosure, the signal from the portable device 2 is also referred to as a device signal. A unique communication device number is set for each BLE communication device 7. The communication device number functions as information for identifying the multiple BLE communication devices 7. In the storage 43, installation positions of the BLE communication device 7 are stored as communication device setting data in association with the communication device number. For each BLE communication device 7, a mounting position and role-sharing will be separately described later.

The power supply ECU 11 is an ECU that controls on and off states of the traveling power supply mounted on the vehicle Hv. For example, the power supply ECU 11 switches the traveling power supply from off to on based on an instruction signal from the smart ECU 4. When the vehicle Hv is an engine vehicle, the power supply ECU 11 starts the engine based on an instruction signal from the smart ECU 4.

The body ECU 12 is an ECU that controls the body system actuator 13 based on a request from the smart ECU 4 or the user. The body ECU 12 is communicably connected to various body system actuators 13 and various body system sensors 14. The body system actuator 13 is, for example, a door lock motor constituting a locking mechanism of each door. The body system sensor 14 includes a courtesy switch and the like disposed for each door. The courtesy switch is a sensor that detects opening and closing of the door. The body ECU 12 locks or unlocks each door by outputting a predetermined control signal to the door lock motor provided for each door of the vehicle Hv, for example, based on a request from the smart ECU 4.

The display 15 is, for example, a liquid crystal display or an organic EL display. The display 15 displays an image corresponding to an input signal from the smart ECU 4. The display 15 is disposed, for example, in a central region of the instrument panel in the vehicle width direction or a front region of the driver's seat. The display 15 corresponds to an in-vehicle display.

The input device 16 is a device for receiving an instruction operation of the user on the smart ECU 4. As the input device 16, for example, a touch panel stacked on the display 15 can be adopted. The input device 16 may be a mechanical switch provided on a steering wheel, the instrument panel, or the like. The input device 16 outputs, as an operation signal, an electric signal corresponding to an operation performed by the user on the device to the smart ECU 4. The operation signal output by the input device 16 indicates operation content of the user. The display 15 and the input device 16 correspond to an interface for the user to input a predetermined passcode or the like to the smart ECU 4. The display 15 and the input device 16 are collectively referred to as an in-vehicle HMI. The HMI is an abbreviation for human machine interface.

The biometric authentication device 17 is a device that authenticates the user using biometric information of the user, for example, a fingerprint or a face image. The biometric authentication device 17 may be a device that authenticates a user using a vein pattern of a hand or a finger or an iris pattern. The biometric authentication device 17 may be a device that identifies the user using a feature of a spoken voice such as a voiceprint. The biometric authentication device 17 is driven based on, for example, an instruction from the smart ECU 4. The biometric authentication device 17 outputs an authentication result of the user to the smart ECU 4. The biometric authentication device 17 may simply acquire biometric information used for user authentication (that is, may be a reading device). In this case, the smart ECU 4 performs a user authentication process by comparing biometric information acquired by the biometric authentication device 17 with biometric information registered in advance.

### Regarding Mounting Position and Role of BLE Communication Device

Here, the mounting position and role of each BLE communication device 7 will be described with reference to FIG. 3. As described above, the in-vehicle system 1 of the present embodiment includes the BLE communication devices 7a, 7b, 7c, 7p, and 7x. The BLE communication devices 7a, 7b, 7c, 7p, and 7x correspond to communication devices conforming to the same communication standard, in other words, communication devices using the same communication band.

The BLE communication device 7a is the BLE communication device 7 provided at an outer door handle of the driver's seat. The BLE communication device 7a can be called a right communication device. The BLE communication device 7b is the BLE communication device 7 provided at an outer door handle of a front passenger seat. The BLE communication device 7b can be called a left communication device. The BLE communication device 7c is the BLE communication device 7 provided in the vicinity of a trunk door. The BLE communication device 7c can be called a rear communication device. The BLE communication devices 7a, 7b, and 7c correspond to an outside-cabin unit that is the BLE communication device 7 disposed at an outer surface portion of the vehicle Hv.

Each of the BLE communication devices 7a, 7b, and 7c is disposed so as to form a locking and unlocking area EA at a desired position outside the vehicle cabin. The locking and unlocking area EA is an area for the in-vehicle system 1 to execute predetermined vehicle control such as locking or unlocking of a door based on the presence of the portable device 2 in the area. The locking and unlocking area EA is a type of cabin-outside working area and can also be referred to as a passive entry area. For example, a range within a predetermined working distance from the outer door handle provided at each of a driver's seat door, a front passenger's seat door, and the trunk door is set as the locking and unlocking area EA. The working distance that defines a size of the locking and unlocking area EA is, for example, 1.5 m. Of course, the working distance may be 1 m or 0.7 m. The working distance is set to be smaller than 2 m from the viewpoint of security. The BLE communication devices 7a, 7b, and 7c correspond to a locking and unlocking area forming device.

The BLE communication device 7p is the BLE communication device 7 disposed in the vehicle cabin. The BLE communication device 7p is disposed at the center of the instrument panel in the vehicle width direction or at a front portion of the driver's seat so as to form a start area SA around the driver's seat. The BLE communication device 7p can be called an in-cabin unit. In particular, the BLE communication device 7p can be referred to as a front in-cabin unit.

The start area SA is an area for the in-vehicle system 1 performs vehicle control of switching the traveling power supply from off to on based on the presence of the portable device 2 in the area. In other words, the start area SA is an area for permitting the start of the driving source. The start area SA is a type of in-cabin working area and can also be referred to as a passive start area. For example, a range within 0.5 m from the center of the instrument panel in the vehicle width direction in the cabin is set as the start area SA. The smart ECU 4 may handle an in-cabin area, which is within a certain distance from the BLE communication device 7p, as the start area.

The BLE communication device 7p may be disposed in the vicinity of a shift lever, in the vicinity of the start button 6, or at a center console. The vicinity of the start button 6 includes a back side of the start button 6 and the inside of the start button 6. The BLE communication device 7p may be disposed in the vicinity of a steering column cover or at the foot of the driver's seat. The BLE communication device 7p may be disposed at a vehicle inner side surface of the driver's seat door, for example, a door pocket, or at a base of a B pillar on a driver's seat side. The B pillar refers to the second pillar from the front among the pillars of the vehicle Hv. The B pillar may also be referred to as a center pillar. The base of the B pillar refers to a portion within 0.2 m from the floor.

In the present disclosure, the BLE communication device 7 that forms the start area SA as the BLE communication device 7p is also referred to as a start area forming device. The BLE communication device 7p corresponds to a first communication device. In the present embodiment, the BLE communication devices 7a and 7b are set as substitute devices. The substitute device is the BLE communication device 7 that forms a temporary start area only when a failure occurs in the start area forming device. For example, the BLE communication device 7 closest to the start area forming device among the BLE communication devices other than the start area forming device is set as the substitute device. Multiple substitute devices may be provided, and here, the BLE communication devices 7a and 7b are set as the substitute devices. The BLE communication devices 7a and 7b serving as the substitute devices correspond to a second communication device.

The BLE communication device 7x is the BLE communication device 7 built in the smart ECU 4. The BLE communication device 7x is used for data communication with the portable device 2. In the present disclosure, the communication device used for data communication with the portable device 2 is also referred to as a gateway communication device. The gateway communication device can also be referred to as a representative device, a central device, a data communication device, or the like. The BLE communication device 7x may be disposed outside the housing of the smart ECU 4. Setting of the gateway communication device may be dynamically changed by the smart ECU 4. For example, when a failure of the BLE communication device 7x is detected, the smart ECU 4 may cause the BLE communication device 7p to function as a gateway communication device. The start area forming device and the gateway communication device may be the same BLE communication device 7.

Upon receiving the advertisement signal from the portable device 2, the BLE communication device 7x automatically establishes the communication connection with the portable device 2 using stored device information. After the communication connection is established, the smart ECU 4 starts encrypted data communication with the portable device 2. When the communication connection with the portable device 2 is established, the BLE communication device 7x provides the device ID of the portable device 2, which is in communication connection, as connected device information to the processor 41.

The smart ECU 4 uses the BLE communication device 7 other than the BLE communication device 7x as a communication device for determining the device position (that is, for position determination). In one aspect, the BLE communication device 7 for position determination corresponds to the BLE communication device 7 for measuring a distance to the portable device 2. The BLE communication device 7 for position determination is also referred to as an observation device in the present disclosure. In the present embodiment, the BLE communication device 7a, the BLE communication device 7b, the BLE communication device 7c, and the BLE communication device 7p correspond to the observation device. The observation device can also be called a distance measurement device or a satellite communication device. Alternatively, the smart ECU 4 may cause each of the multiple BLE communication devices 7 to perform data communication with the portable device 2.

In the BLE communication, in a state where communication connection between devices is established, data is transmitted and received while sequentially changing 37 channels. That is, frequency hopping is performed during data communication after connection establishment. Therefore, normally, only the BLE communication device 7x performing the communication connection can acquire a data signal from the portable device 2. The observation device cannot observe the device signal.

In a configuration corresponding to such a situation, the BLE communication device 7x of the present embodiment sequentially provides information (hereinafter, channel information) indicating a channel used for the communication with the portable device 2 to the smart ECU 4. The channel information may be a specific channel number, or may be a parameter (so-called hopIncrement) indicating a transition rule of a used channel. The hopIncrement is a number from 5 to 16 that is randomly determined during the communication connection. The channel information preferably includes the current channel number and the hopIncrement.

The smart ECU 4 distributes the channel information and the device ID acquired from the BLE communication device 7x to each observation device as reference information. According to the channel information indicated by the reference information, each of the observation devices can recognize which channel among many channels usable in BLE should be used to receive the device signal. As a result, the observation device can detect and report the reception strength and the like of the device signal even without communication connection.

In the present disclosure, the method of determining the device position based on a reception state of a signal, which is transmitted from the portable device 2 to the gateway communication device, at the observation device is also referred to as a sniffing method. According to the sniffing method, since it is possible to reduce the number of BLE communication devices 7 to one at minimum with which the portable device 2 is in communication connection, it is possible to reduce the power consumption of the portable device 2. According to the sniffing method, indices indicating distances from the multiple BLE communication devices 7 to the portable device 2 can be collected in parallel, and thus it is possible to improve system responsiveness with respect to approach of a user carrying the portable device 2. Alternatively, each BLE communication device 7 may individually perform bidirectional communication with the portable device 2 and provide information such as the reception strength to the smart ECU 4.

### Regarding Function of Smart ECU 4

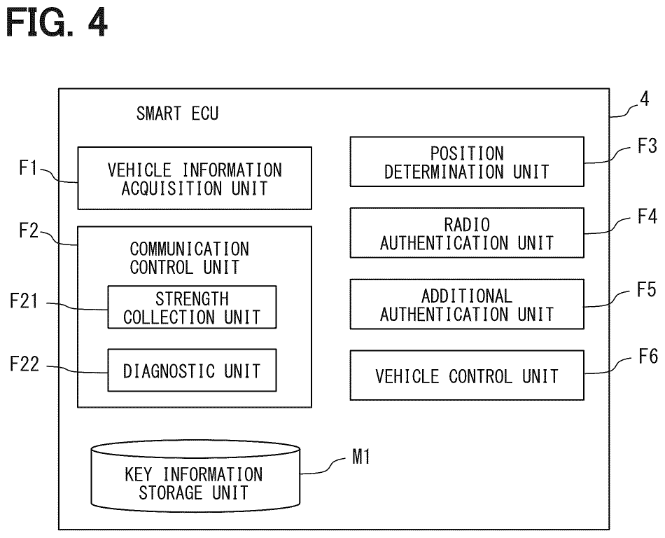

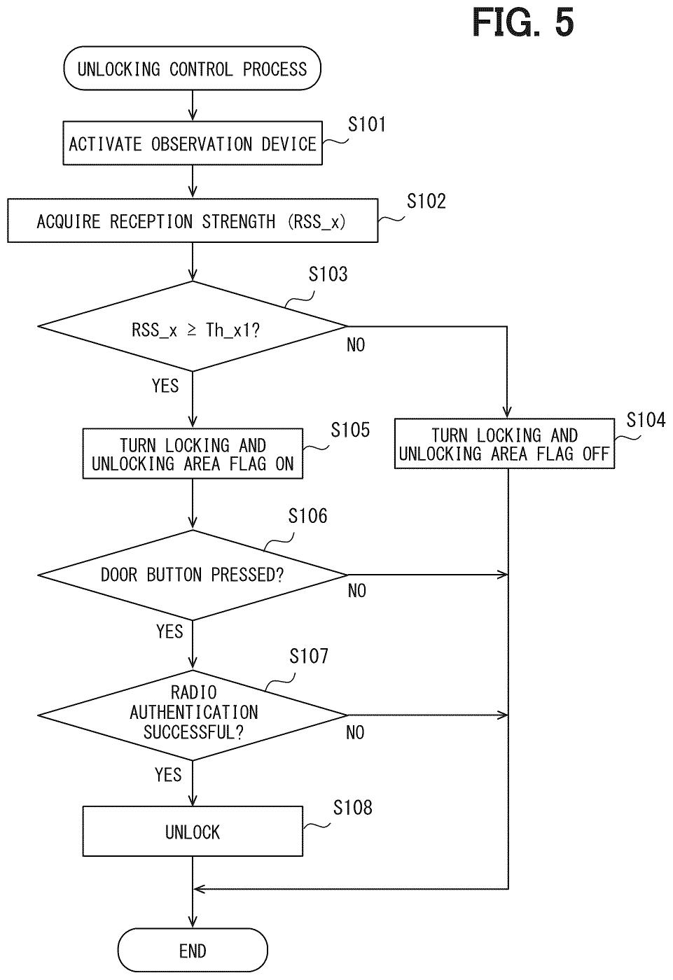

Here, a function and an operation of the smart ECU 4 will be described with reference to FIG. 4. The smart ECU 4 provides functions corresponding to various functional blocks illustrated in FIG. 5 by executing programs stored in the storage 43. That is, the smart ECU 4 includes a vehicle information acquisition unit F1, a communication control unit F2, a position determination unit F3, a radio authentication unit F4, an additional authentication unit F5, and a vehicle control unit F6 as functional units. The communication control unit F2 includes a strength collection unit F21 and a diagnostic unit F22 as sub-functional units. The smart ECU 4 further includes a key information storage unit M1.

The key information storage unit M1 is a storage medium for storing information on the portable device 2 that is used as an electronic key of the vehicle Hv. The key information storage unit M1 stores information on at least one portable device 2. In the key information storage unit M1, key information for each portable device 2 is stored in association with a key ID, a device ID, a user ID, and the like. The user ID is an identifier for identifying multiple users and is set for each user. The key information may be stored in association with information such as an expiration date, authority, and a seat position. The key information storage unit M1 is implemented by using a part of a storage area of the storage 43. The key information storage unit M1 may be implemented using a nonvolatile storage medium physically independent of the storage 43. The key information storage unit M1 allows the processor 41 to write, read, and delete data therein.

The vehicle information acquisition unit F1 acquires various types of vehicle information indicating a state of the vehicle Hv and an operation of the user on the vehicle Hv from sensors, ECUs, switches, and the like mounted on the vehicle Hv. The vehicle information includes, for example, a state (on/off) of the traveling power supply, an opening and closing state of each door, a locked/unlocked state of each door, a pressed state of the door button 5 and the start button 6, a shift position, and the like. An output value of a brake sensor that detects a depression amount/depression force of the brake pedal and a signal indicating an operating state of a parking brake may also correspond to the vehicle information. Acquiring the electric signals from the door button 5 and the start button 6 corresponds to detecting user operations on these buttons. In one aspect, the vehicle information acquisition unit F1 corresponds to a configuration that detects an operation of the user on the vehicle Hv, such as pressing of the door button 5, opening and closing of the door, or pressing of the start button 6.

The vehicle information acquisition unit F1 acquires a current state of the vehicle Hv based on the various types of information described above. For example, when the traveling power supply is off and all the doors are locked, the vehicle information acquisition unit F1 determines that the vehicle Hv is parked. A condition for determining that the vehicle Hv is parked may be appropriately designed, and various determination conditions can be applied. The “acquisition” in the present disclosure includes generation/detection/determination by internal arithmetic based on data or the like received from another device/sensor. This is because the functional arrangement in the system is appropriately changed.

The communication control unit F2 controls the operation of the BLE communication device 7. The communication control unit F2 executes a key exchange protocol (so-called pairing) with the portable device 2 by using the BLE communication device 7x, for example, at the time of registration of the user. The device information, which is information on the portable device 2 acquired by the pairing, is stored in the storage 43 and is also stored in a nonvolatile memory provided in the communication microcomputer 73 of each BLE communication device 7. The device information is, for example, a key exchanged by pairing or a device ID.

The communication control unit F2 acquires the device ID of the portable device 2 being in the communication connection from the BLE communication device 7x. The smart ECU 4 specifies the user present around the vehicle Hv based on the received device ID. When the vehicle Hv is shared by multiple users, the device information on the portable devices 2 owned by the users is stored. When the vehicle Hv is a service car, the smart ECU 4 may acquire in advance the device information corresponding to a user who makes a use reservation from a digital key server that issues the key information, and temporarily store the device information in a predetermined storage medium.

When receiving a signal transmitted from the portable device 2 via the BLE communication device 7x, for example, an advertisement signal, the communication control unit F2 detects the presence of the portable device 2 within a range where the portable device 2 can perform the short-range communication with the in-vehicle system 1. That is, the BLE communication device 7x detects the portable device 2 present around the vehicle by a passive scan method. The in-vehicle system 1 may search for the portable device 2 by an active scan method involving transmission of a scan request. The two types of scan methods may be used depending on the scene. For example, the passive scan method may be adopted in a standby scene during parking, and the active scan method may be adopted when a predetermined collation event such as pressing of the door button 5 occurs.

The communication control unit F2 performs data communication with the portable device 2 using the BLE communication device 7x. For example, the communication control unit F2 generates data addressed to the portable device 2 in the connection communication and outputs the data to the BLE communication device 7x. Accordingly, a signal corresponding to desired data is transmitted as a radio wave. The communication control unit F2 receives data from the portable device 2 received by the BLE communication device 7x.

While the vehicle Hv is parked, the communication control unit F2 maintains the BLE communication device 7x serving as a gate communication device in a state (so-called standby state) of capable of receiving the device signal, and shifts the observation device to a dormant state. The dormant state is, for example, a state in which a signal receiving function is stopped. The dormant state includes a state in which the power supply is turned off. Accordingly, a dark current during parking can be restricted.

In addition, the communication control unit F2 acquires the reception strength for each frequency of the device signal from each BLE communication device 7. A configuration of acquiring the reception strength for each frequency for each communication device corresponds to the strength collection unit F21. The communication control unit F2 may temporarily change the gateway communication device for position determination of the portable device 2.

The communication control unit F2 includes the diagnostic unit F22 as a sub-functional unit. The diagnostic unit F22 determines whether the BLE communication device 7 to be diagnosed is operating normally, in other words, whether a failure has occurred. The communication control unit F2 periodically determines whether the BLE communication device 7x is operating normally, for example. In addition, the observation device such as the BLE communication device 7p is diagnosed periodically or using the establishment of connection between the BLE communication device 7x and the portable device 2 as a trigger. The diagnostic unit F22 may periodically diagnose the observation device. When the smart ECU 4 is capable of executing multiple arithmetic processes in parallel, for example, when the smart ECU 4 includes multiple processors, the diagnostic unit F22 may diagnose the multiple BLE communication devices 7 simultaneously (in parallel).

A case where a failure has occurred in the BLE communication device 7p includes a case where an abnormality has occurred in an internal circuit or the communication microcomputer 73 of the BLE communication device 7p. The case where a failure has occurred in the BLE communication device 7p may include a case where a disconnection or a connection failure has occurred in a communication line connecting the BLE communication device 7p and the smart ECU 4. The disconnection of the communication line connecting the BLE communication device 7p and the smart ECU 4, a connection failure of a connector thereof, or the like also corresponds to the case where a failure has occurred in the BLE communication device 7p. The same applies to the failure of the other BLE communication devices 7. The BLE communication device 7 that cannot normally communicate with the smart ECU 4 corresponds to the BLE communication device 7 in which a failure has occurred.

The diagnostic unit F22 can detect the failure of the BLE communication device 7 using various methods such as a watchdog timer method and a homework answering method. The watchdog timer method is a method of determining that a failure has occurred in the BLE communication device 7 when a watchdog timer provided in the smart ECU 4 expires without being cleared by a watchdog pulse received from the BLE communication device 7. The smart ECU 4 may include a watchdog timer corresponding to each BLE communication device 7.

The homework answering method is a method in which the smart ECU 4 sends a predetermined monitoring signal to a device to be diagnosed and determines whether the device to be diagnosed is normal based on whether an answer returned from the device to be diagnosed is a correct answer. The device to be diagnosed refers to the BLE communication device 7 as an object to be diagnosed. The BLE communication device 7 as a device to be diagnosed in the homework answering method generates answer data corresponding to the monitoring signal received from the smart ECU 4 and returns the answer data to the smart ECU 4. The diagnostic unit F22 determines that the device to be diagnosed is not operating normally when the answer data returned from the device to be diagnosed is different from correct answer data corresponding to the transmitted monitoring signal and when a response signal is not returned from the smart ECU 4 within a predetermined time limit. The homework answering method corresponds to a type of communication confirmation.

In addition, the diagnostic unit F22 may detect a failure of the observation device based on the reception strength, a round-trip time (RTT), or the like obtained by causing the observation device to be diagnosed and the BLE communication device 7x to perform wireless communication. The RTT is a time from when a response request signal is transmitted to the object to be diagnosed to when a response signal is received. The diagnostic unit F22 may detect a failure of the observation device based on the fact that the reception strength of the signal from the gateway communication device observed by the observation device deviates from a normal range registered in advance or the fact that the RTT is a predetermined value or more. Each BLE communication device 7 may have a self-diagnosis function and may output an error signal when an internal error is detected. In this case, the diagnostic unit F22 may determine that a failure has occurred in the BLE communication device 7 based on an input of the error signal from the BLE communication device 7. The diagnostic unit F22 may determine that a failure has occurred in the BLE communication device 7, based on the fact that there is no input signal from the BLE communication device 7.

Although the diagnostic unit F22 of the present embodiment diagnoses each of the observation devices and the gateway communication device as an example, the present invention is not limited thereto. The diagnostic unit F22 may diagnose only the BLE communication device 7p as a start area forming device. By narrowing down the object to be diagnosed, the processing load of the smart ECU 4 can be reduced.

The smart ECU 4 of the present embodiment includes a normal mode and a temporary mode as operating modes related to on-off control of the traveling power supply. The temporary mode is an operating mode in the case where the diagnostic unit F22 detects a failure in the BLE communication device 7p serving as the start area forming device. The normal mode is an operating mode in the case where no failure is detected in the BLE communication device 7p. When the diagnostic unit F22 detects the failure of the BLE communication device 7p, the smart ECU 4 shifts from the normal mode to the temporary mode. When the diagnostic unit F22 confirms that the BLE communication device 7p is operating normally, the mode returns from the temporary mode to the normal mode.

The normal mode and the temporary mode are different from each other in data (material)/algorithm used for determining whether the portable device 2 exists in the start area SA. The temporary mode corresponds to an operating mode of permitting the traveling power supply to be turned on by pressing of the start button 6 based on the fact that the reception state of the device signal at the substitute device satisfies a predetermined temporary area determination condition even when a failure has occurred in the BLE communication device 7p. Operations of the smart ECU 4 in the normal mode and the temporary mode will be described later.

The position determination unit F3 determines the device position based on the reception state of the device signal at each BLE communication device 7. The position determination unit F3 determines whether the portable device 2 is present in the locking and unlocking area EA based on the reception strength of the device signal observed in the outside-cabin unit. The position determination unit F3 determines whether the portable device 2 is present in the start area SA based on the reception strength of the device signal observed by the BLE communication device 7p in the normal mode. The position determination unit F3 determines whether the portable device 2 is present in the start area SA based on the reception strength of the device signal observed by the predetermined BLE communication device 7 other than the BLE communication device 7p in the temporary mode.

Determining that the portable device 2 is present in the start area corresponds to determining that a device position condition that is a condition related to the device position among start conditions is satisfied, the start conditions being conditions for starting the driving source. The start conditions include, in addition to the device position condition, a success in authentication of the portable device 2/the user and a vehicle state condition that is a condition related to a vehicle state. The vehicle state condition constituting the start condition is, for example, that the brake pedal is depressed and that the shift position is set to parking or neutral.

The radio authentication unit F4 cooperates with the BLE communication device 7x to perform a process of confirming (in other words, authenticating) that a communication partner is the portable device 2. The communication for authentication is performed in an encrypted manner. The authentication process itself may be performed using various methods such as a challenge response method. For example, the radio authentication unit F4 transmits a predetermined/randomly generated challenge code to the portable device 2. A verification code is generated in the challenge code by a predetermined procedure using key information corresponding to a device ID/key ID of the communication partner. Then, a response code returned from the communication partner is collated with the verification code, and it is determined that the authentication is successful based on the fact that the response code and the verification code coincide with each other. Such an authentication process is accompanied by a process of collating the response code generated by the portable device 2 based on the key information with the verification code held or dynamically generated by the smart ECU 4. The successful authentication of the portable device 2 corresponds to determining that the person who attempts to access the vehicle Hv is an authorized user.

A timing at which the radio authentication unit F4 performs the authentication process may be, for example, a timing at which the communication connection between the BLE communication device 7 and the portable device 2 is established. The radio authentication unit F4 may perform the authentication process at a predetermined cycle while the BLE communication device 7 and the portable device 2 are in communication connection. In addition, the smart ECU 4 may perform communication for the authentication process using a predetermined user operation on the vehicle Hv as a trigger, such as pressing of the door button 5 or pressing of the start button 6 by the user.

The additional authentication unit F5 authenticates that an occupant is an authorized user by a method other than radio authentication. When the authentication performed by the radio authentication unit F4, that is, the authentication performed based on the wireless communication with the portable device 2 is defined as a first-stage authentication process, the additional authentication unit F5 corresponds to a configuration that performs a second-stage authentication. In the present disclosure, the authentication process performed by the additional authentication unit F5 is also referred to as an additional authentication process. When the temporary mode is applied and it is detected that the user has unlocked and got in the vehicle Hv, the additional authentication unit F5 performs the additional authentication process. The additional authentication process is implemented, for example, in cooperation with the biometric authentication device 17. Specifically, the additional authentication process includes displaying an authentication request screen on the display 15 for requesting implementation of biometric authentication and includes activating the biometric authentication device 17. The additional authentication unit F5 acquires the authentication result of the user from the biometric authentication device 17. The execution request for biometric authentication may be made by outputting a predetermined voice message from a speaker.

The additional authentication process may be a process of determining the validity of the user by inputting a passcode. For example, when the temporary mode is applied and it is detected that the user has unlocked and got in the vehicle Hv, the additional authentication unit F5 requests the user to input a predetermined passcode. The passcode may be dynamically generated or may be a code registered by the user in advance. The passcode may be a code (so-called password) set at the time of user registration.

For example, when in the temporary mode, the additional authentication unit F5 dynamically generates a one-time passcode that is a passcode that is valid only once, and transmits the one-time passcode to the portable device 2 by BLE communication. Then, an input screen of the one-time passcode is displayed on the display 15. The additional authentication unit F5 may determine the validity of the occupant using the passcode input by the user.

The vehicle control unit F6 executes vehicle control according to the position of the portable device 2 (in other words, the user) and the state of the vehicle Hv in cooperation with the body ECU 12 or the like at least on condition that the authentication of the portable device 2 by the radio authentication unit F4 is successful. For example, when the position determination unit F3 determines that the portable device 2 is present in the locking and unlocking area EA and it is detected that the door button 5 is pressed by the user, the vehicle control unit F6 unlocks the door in cooperation with the body ECU 12. When the position determination unit F3 determines that the portable device 2 is present in the start area SA and it is detected that the start button 6 is pressed by the user, the vehicle control unit F6 switches the traveling power supply from off to on in cooperation with the power supply ECU 11.

As to be described below, the smart ECU 4 described above performs an unlocking control process, an operating mode control process, and a start control process.

### Regarding Unlocking Control Process

Here, the unlocking control process performed by the smart ECU 4 will be described with reference to a flowchart illustrated in FIG. 5. The unlocking control process is a process for unlocking all doors or a specific door of the vehicle Hv in response to the door button 5 pressed by the user. The unlocking control process corresponds to a sequence for providing a passive entry function.

The unlocking control process may be executed based on the reception of the device signal by the BLE communication device 7x in a state where the vehicle Hv is locked. The unlocking control process is performed, for example, every 200 milliseconds (periodically) as long as the device signal is being received in the state where the vehicle Hv is locked. The unlocking control process includes steps S101 to S108 as an example.

S101 is a step of activating the observation device. That is, by inputting a predetermined control signal to each observation device, the observation device is shifted from the dormant state to the standby state. When the observation device has already been activated, S101 may be omitted. The observation device to be activated in the unlocking control process may be only the outside-cabin unit. The in-cabin unit may be maintained in the dormant state.

S102 is a step of acquiring the reception strength of the device signal from each observation device. RSS_x in the drawing indicates outside-cabin unit observed strength that is the reception strength at the outside-cabin unit. The processor 41 determines whether an outside-cabin unit is present, whose outside-cabin unit observed strength (RSS_x) is equal to or greater than a predetermined locking and unlocking area determination value (Th_x1), among the multiple outside-cabin units by using the reception strength for each out-side unit acquired in S102 (S103).

When no outside-cabin unit is present whose outside-cabin unit observed strength is equal to or greater than the locking and unlocking area determination value, the processor 41 sets a locking and unlocking area flag to OFF and ends the flow (S104). On the other hand, when an outside-cabin unit is present whose outside-cabin unit observed strength is equal to or greater than the locking and unlocking area determination value, the locking and unlocking area flag is set to ON (S105). The locking and unlocking area flag is a processing flag indicating whether the portable device 2 is present in the locking and unlocking area EA. Setting the locking and unlocking area flag to ON corresponds to determining that the portable device 2 is present in the locking and unlocking area EA. The above process corresponds to a process in which the position determination unit F3 determines that the portable device 2 is present in the locking and unlocking area EA when an outside-cabin unit is present whose reception strength is equal to or greater than a predetermined value.

S106 is a step in which the processor 41 determines, based on an input signal from the door button 5, whether the door button 5 is pressed. When the door button 5 is pressed, the process proceeds to S107. On the other hand, when the door button 5 is not pressed, the flow is ended. When it is detected that the door button 5 is pressed in a state where the locking and unlocking area flag is set to OFF, the processor 41 may cause the display 15 to display a key non-detection image. The key non-detection image is an image indicating that the portable device 2 is not found near the door.

S107 is a step of determining whether a radio authentication process is successful. The radio authentication process may be performed using pressing of the door button 5 as a trigger, or may be performed before the door button 5 is pressed using the communication connection with the portable device 2 as a trigger. When the radio authentication process is successful, the processor 41 unlocks each door (S108). On the other hand, when the radio authentication process is not successful, the flow is ended. At this time, the processor 41 may display an authentication failure image on the display 15. The authentication failure image is an image indicating that the user authentication (radio authentication) has failed.

The locking and unlocking area determination value (Th_x1) used in the above flow is a parameter for determining that the portable device 2 is present in the locking and unlocking area EA, and a specific value thereof may be appropriately designed. The reception strength of each outside-cabin unit used for comparison with the locking and unlocking area determination value may be an average value, a median value, or a maximum value of the reception strength of the device signals observed in the same in-cabin unit within the latest predetermined time.

### Operating Mode Control Process

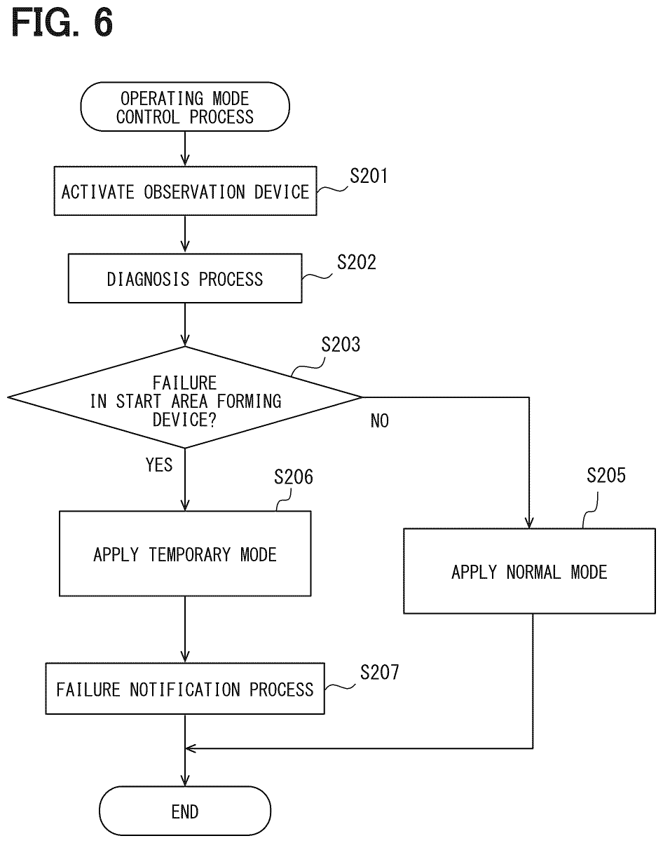

Here, the operating mode control process performed by the smart ECU 4 will be described with reference to a flowchart illustrated in FIG. 6. The operating mode control process corresponds to a process for switching from the normal mode to the temporary mode. The operating mode control process may be executed, for example, based on the fact that the door of the vehicle Hv is unlocked in the unlocking control process described above. The operating mode control process may be executed using, as a trigger, the reception of advertisement from the portable device 2, the establishment of the communication connection with the portable device 2, the success of the radio authentication process of the portable device 2, and the like. Various conditions can be adopted as execution conditions of the operating mode control process.

The operating mode control process includes steps S201 to S207 as an example. S201 is a step of activating the observation device in the dormant state. The observation device activated in S201 may be only the BLE communication device 7p serving as the start area forming device.

S202 is a step in which the diagnostic unit F22 determines whether the BLE communication device 7p is operating normally. Whether the BLE communication device 7p is operating normally can be determined by various methods such as wired or wireless communication confirmation as described above. When no failure is detected in the BLE communication device 7p as a result of a diagnosis process in S202 (S203: NO), the normal mode is applied. The case where no failure is detected in the BLE communication device 7p corresponds to a case where it is confirmed that the start area forming device is operating normally. On the other hand, when a failure is detected in the BLE communication device 7p as a result of the diagnosis process in S202 (S203: YES), the processor 41 shifts the operating mode to the temporary mode.

When the operating mode is shifted to the temporary mode, the processor 41 performs a failure notification process (S207). The failure notification process is a process of displaying, on the display 15, a failure notification image that is an image indicating that the BLE communication device 7p is not operating normally or operating in the temporary mode. The failure notification process may be a process of outputting a voice message from the speaker indicating that the BLE communication device 7p is not operating normally or operating in the temporary mode. The failure notification process may include displaying a predetermined image on the display of the portable device 2 connected to the smart ECU 4 through the BLE communication.

Further, the failure notification process may include transmitting, via a center/server, a temporary mode application notification that is a message indicating that the mode is shifted to the temporary mode, to a device/a notification destination registered in the smart ECU 4 in advance. A transmission destination of the temporary mode application notification may be represented by a mail address, a telephone number, a device ID, a device token of a vehicle management application, or the like. The vehicle management application is an application that enables the state of the vehicle Hv to be checked on an external device such as the portable device 2 in cooperation with a server or the like. A device registered as the transmission destination of the temporary mode application notification corresponds to a vehicle coordination device that is a device associated with the smart ECU 4 (and thus the vehicle Hv). For example, a device in which the vehicle management application is installed and whose association with the smart ECU 4/the vehicle Hv is completed is the vehicle coordination device.

A communication failure with the BLE communication device 7p may occur accidentally (temporarily) due to a contact failure of the connector, noise, or the like. In view of such circumstances, the processor 41 may periodically diagnose the BLE communication device 7p while operating in the temporary mode. According to the configuration of periodically diagnosing the BLE communication device 7p, if a failure of the BLE communication device 7p is accidental, the operating mode can return to the normal mode with the passage of time. In order to restrict an erroneous diagnosis due to an accidental cause, the processor 41 may determine that a failure has occurred in the BLE communication device 7p based on a fact that a communication failure with the BLE communication device 7p has continuously occurred a predetermined number of times.

### Start Control Process in Normal Mode

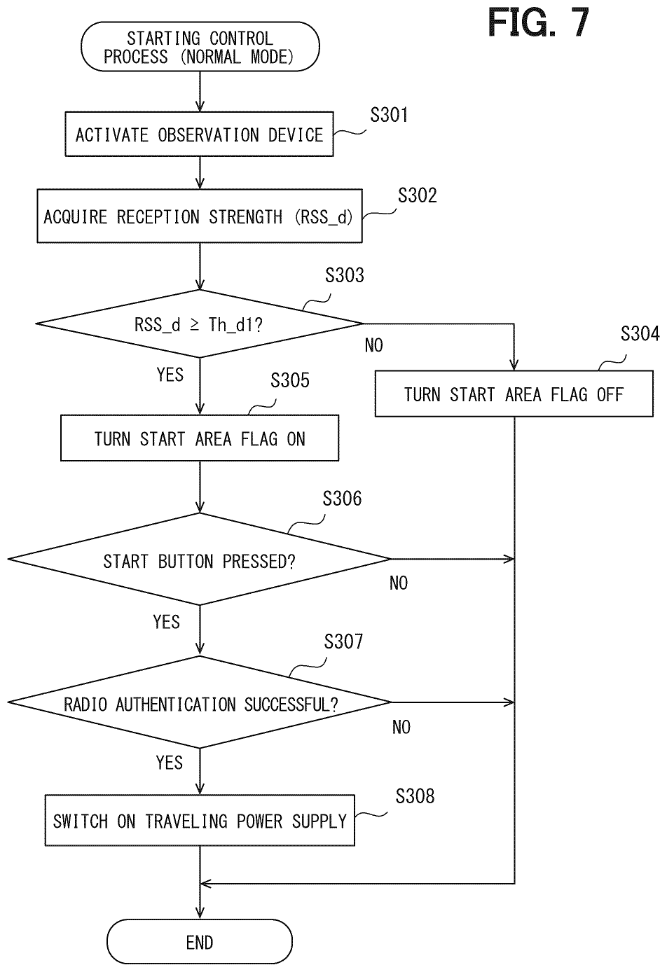

Here, the start control process in the normal mode performed by the smart ECU 4 will be described with reference to a flowchart illustrated in FIG. 7. The start control process corresponds to a process of switching the vehicle Hv to a travelable state, that is, a process of switching the traveling power supply from off to on. The start control process may be periodically executed, for example, based on the fact that the door of the vehicle Hv is unlocked in the above-described unlocking control process. The start control process may be periodically executed on the condition that the brake pedal is depressed.

The start control process in the normal mode includes steps S301 to S308 as an example. S301 is a step of activating the observation device in the dormant state. The observation device activated in S301 may be only the BLE communication device 7p serving as the start area forming device. The observation device to be activated may be selected according to a condition for determining that the portable device 2 is present in the start area SA.

S302 is a step of acquiring the reception strength of the device signal from the BLE communication device 7p. RSS_d in the drawing indicates the reception strength at the BLE communication device 7p serving as the start area forming device. The processor 41 determines whether the reception strength (RSS_d) at the BLE communication device 7p acquired in S302 is equal to or greater than a predetermined start area determination value (Th_d1) (S303).

When the reception strength at the BLE communication device 7p is less than the start area determination value, the processor 41 sets the start area flag to OFF and ends the flow (S304). On the other hand, when the reception strength at the BLE communication device 7p is equal to or greater than the start area determination value, the processor 41 sets the start area flag to ON (S305).

The start area flag is a processing flag indicating whether the portable device 2 is present in the start area SA. Setting the start area flag to ON corresponds to determining that the portable device 2 is present in the start area SA. The above process corresponds to a process in which the position determination unit F3 determines that the portable device 2 is present in the start area SA when the reception strength at the BLE communication device 7p is equal to or greater than a predetermined value.

S306 is a step in which the processor 41 determines whether the start button 6 is pressed based on the input signal from the start button 6. When the start button 6 is pressed, the process proceeds to S307. On the other hand, when the start button 6 is not pressed (S306: NO), the flow is ended.

S307 is a step of determining whether the radio authentication process is successful. As described above, the radio authentication process may be performed using the pressing of the start button 6 as a trigger, or may be performed in advance using the communication connection with the portable device 2 as a trigger. When the radio authentication process is successful, the processor 41 switches the traveling power supply from off to on (S308).

The start area determination value (Th_d1) used in the determination process of S303 is a parameter for determining that the portable device 2 is present in the start area SA based on the reception strength at the BLE communication device 7p, and a specific value thereof may be appropriately designed. The reception strength at the BLE communication device 7p used for the comparison with the start area determination value may be an average value, a median value, or a maximum value of the reception strength of the device signals observed in the BLE communication device 7p within the latest predetermined time. Alternatively, an average value of the reception strength for each frequency may be used. The determination process of S306 may be a process of determining whether the start button 6 is depressed in a state where the brake pedal is depressed.

### Start Control Process in Temporary Mode

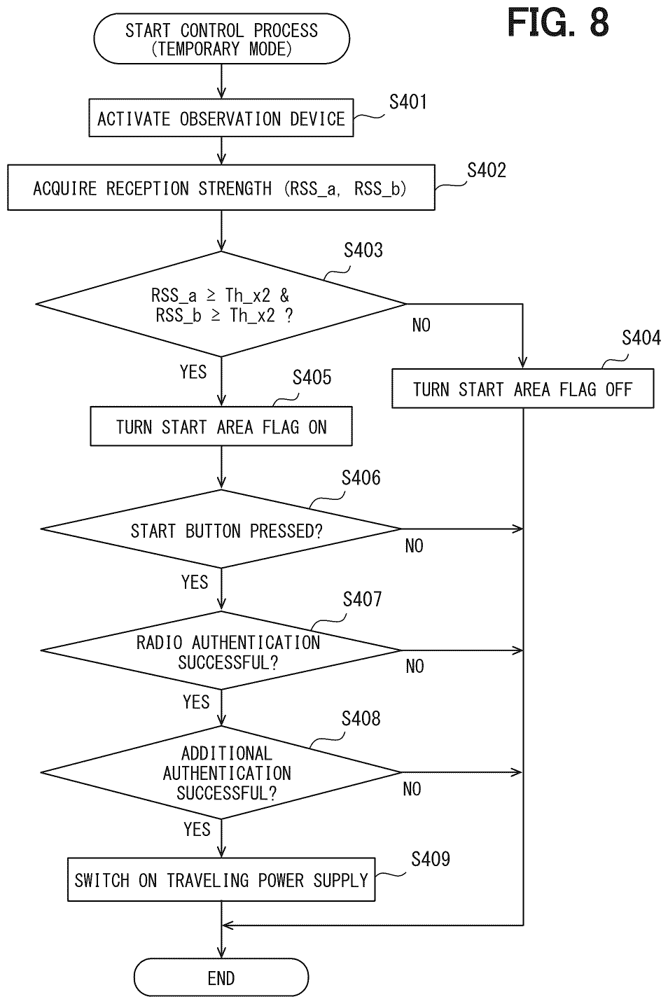

Here, the start control process in the temporary mode performed by the smart ECU 4 will be described with reference to a flowchart illustrated in FIG. 8. The start control process in the temporary mode includes steps S401 to S409 as an example. S401 is a step of activating the observation device in the dormant state as in S301. The observation device to be activated in S401 may be only the substitute device, specifically, only the BLE communication devices 7a and 7b.

S402 is a step of acquiring the reception strength of the device signal from each of the BLE communication devices 7a and 7b serving as the substitute devices. RSS_a in the drawing indicates the reception strength at the BLE communication device 7a. RSS_b in the drawing indicates the reception strength at the BLE communication device 7b. For simplification of description, here, the reception strength (RSS_a) at the BLE communication device 7a is also referred to as right-side reception strength, and the reception strength (RSS_b) at the BLE communication device 7b is also referred to as left-side reception strength. The processor 41 determines whether both the right-side reception strength and the left-side reception strength acquired in S302 are equal to or greater than a temporary start area determination value (Th_x2) (S403). In the present embodiment, both the right-side reception strength and the left-side reception strength being equal to or greater than the temporary start area determination value corresponds to a temporary area determination condition. S403 corresponds to a step of determining whether the data indicating the reception state of the device signal at the substitute device satisfies the temporary area determination condition.

When at least one of the right-side reception strength and the left-side reception strength is less than the temporary start area determination value, the processor 41 sets the start area flag to OFF and ends the flow (S404). On the other hand, when both the right-side reception strength and the left-side reception strength are equal to or greater than the temporary start area determination value, the processor 41 sets the start area flag to ON (S405).

The reception strength at the BLE communication device 7a used in the determination process of S403 may be an average value, a median value, or a maximum value of the reception strength of the device signals observed in the BLE communication device 7a within the latest predetermined time. The same applies to the reception strength at the BLE communication device 7b.

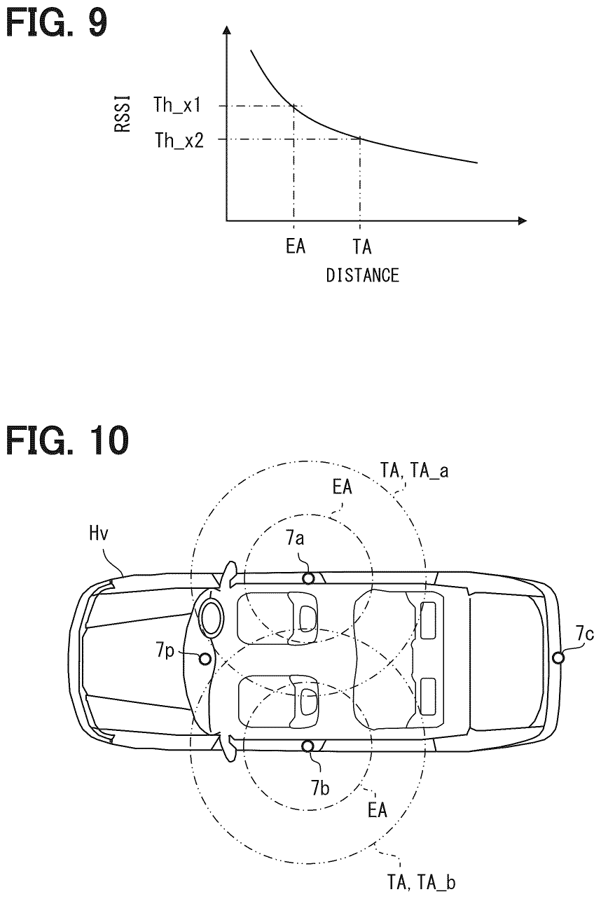

The temporary start area determination value (Th_x2) used in the determination process of S403 is a parameter for determining that the portable device 2 is present in the start area SA based on the reception strength at the substitute device. As illustrated in FIG. 9, the temporary start area determination value is in a range smaller than the locking and unlocking area determination value (Th_x1), and a specific value thereof may be appropriately designed. For example, the temporary start area determination value (Th_x2) is set to a value smaller than the locking and unlocking area determination value (Th_x1) by about 10 dB to 20 dB.

Decreasing an area determination threshold with respect to the reception strength corresponds to enlarging an area to be determined as illustrated in FIG. 10. A two-dot chain line illustrated in FIG. 10 indicates a range in which the reception strength is equal to or greater than the temporary start area determination value, that is, an outline of a temporary threshold excess area. The temporary start area determination value (Th_x2) is set to include at least a part of the original start area.

A place where the reception strength of both the BLE communication devices 7a and 7b can be equal to or greater than the temporary start area determination value corresponds to a portion where a temporary threshold excess area TA_a formed by the BLE communication device 7a and a temporary threshold excess area TA_b formed by the BLE communication device 7b overlap each other in FIG. 10. The processor 41 of the present embodiment handles, as the start area SA in the temporary mode, an area where the temporary threshold excess area TA_a and the temporary threshold excess area TA_b overlap each other. The above process corresponds to a process in which the position determination unit F3 determines that the portable device 2 is present in the start area SA when the reception strength at the BLE communication devices 7a and 7b are both equal to or greater than a predetermined temporary start area determination value smaller than the locking and unlocking area determination value. The start area SA in the temporary mode may be referred to as a temporary start area.

S406 is a step in which the processor 41 determines whether the start button 6 is pressed based on the input signal from the start button 6. When the start button 6 is pressed, the process proceeds to S407. On the other hand, when the start button 6 is not pressed (S406: NO), the flow is ended. The determination process of S406 may be a process of determining whether the start button 6 is pressed in a state where the brake pedal is depressed.

S407 is a step of determining whether the radio authentication process is successful. When the radio authentication process is successful, the processor 41 proceeds to S408 and determines whether the additional authentication process is successful. The display of the authentication request screen in the additional authentication process may be performed using the pressing of the start button 6 as a trigger or using the communication connection with the portable device 2 as a trigger. Further, when the door is unlocked in a state where the temporary mode is applied, or at a timing when the brake pedal is depressed, an execution request for the additional authentication may be made.

When the additional authentication process is successful (S408: YES), the processor 41 proceeds to S409 and switches the traveling power supply from off to on. On the other hand, when the additional authentication process fails, predetermined start impossible notification is performed, and then the flow is ended. The start impossible notification is a process of notifying the user, by displaying an image or outputting a voice message, that the start is impossible since the condition for turning on the traveling power supply is not satisfied. Information output in the start impossible notification may include, for example, a reason why the traveling power supply cannot be set to ON, such as that the portable device 2 is not found in a predetermined area, that a failure occurs in the BLE communication device 7p, or that the additional authentication fails.

### Effects and the Like

When no failure is detected in the BLE communication device 7p, the processor 41 operates in the normal mode. That is, the processor 41 serving as the position determination unit F3 determines that the portable device 2 is present in the start area SA when the reception strength of the device signal observed by the BLE communication device 7p is equal to or greater than a predetermined value. Further, on the condition that it is determined that the portable device 2 is present in the start area SA and the radio authentication process is successful, the pressing of the start button 6 by the user is used as a trigger to switch on the traveling power supply.

On the other hand, when a failure is detected in the BLE communication device 7p, the processor 41 operates in the temporary mode. That is, when the data indicating the communication state with the portable device 2 in the BLE communication device 7 set in advance as a substitute device satisfies a predetermined temporary area determination condition, the position determination unit F3 determines that the portable device 2 is present in the start area SA. Specifically, the position determination unit F3 determines that the portable device 2 is present in the start area SA when the reception strength at the BLE communication devices 7a and 7b for forming the locking and unlocking area EA is equal to or greater than a predetermined value.

According to such a configuration, it is possible to detect that the portable device 2 is present in the start area SA even when a failure occurs in the BLE communication device 7p forming the original start area SA. Consequently, even when a failure occurs in the original start area forming device, the user can cause the vehicle Hv to travel. As a result, the vehicle Hv is allowed to travel to a dealer's shop or a repair shop, and the BLE communication device 7p can be repaired.

The operations in the temporary mode correspond to determining whether the portable device 2 is present in the start area SA by using the BLE communication device 7 that is not used to determine whether the portable device 2 is present in the start area SA in the normal mode. In other words, the above configuration corresponds to a configuration in which the device position condition for switching on the traveling power supply is changed between the normal mode and the temporary mode.

In this case, the start area SA in the temporary mode may be larger than the original start area SA depending on the setting of the temporary area determination condition, that is, the temporary start area formed in the temporary mode may not be as accurate as the original start area. Accordingly, the determination accuracy and the reliability of the device position in the temporary mode may be deteriorated than in the normal mode.

In order to solve the problem, in the above-described embodiment, the processor 41 permits on of the traveling power supply on condition that, in the temporary mode, it is determined that the portable device 2 is present in the start area SA and the additional authentication process is successful in addition to the radio authentication process. As described above, when the temporary mode is applied, the security can be enhanced by including the success of the additional authentication process in the start condition. This is because the additional authentication process requires a vehicle operation performed by the user himself/herself. According to the configuration of the present embodiment, even when a failure occurs in the start area forming device, it is possible to reduce a possibility that a third party who is a person of the user turns on the traveling power supply in an unauthorized manner.

While the embodiment of the present disclosure has been described above, the present disclosure is not limited to the embodiment described above, and various modifications to be described below are included in a technical scope of the present disclosure, and can be implemented by various changes within a scope not departing from the spirit described below. For example, the following various supplements and modifications can be implemented in combination as appropriate as long as technical contradiction does not occur. Members having the same functions as those described above are denoted by the same reference signs, and a description thereof will be omitted. When only a part of a configuration is described, the above description can be applied to other parts.

### Modification (1)

In addition to the case where the diagnostic unit F22 detects a failure of the BLE communication device 7p, for example, the processor 41 may shift to the temporary mode when a specific action of the user is detected. Here, the specific action refers to an action of repeating a start operation a predetermined number of times in a short period. For example, when it is detected that the start operation is performed three times or more within 10 seconds, the processor 41 may apply the temporary mode. The start operation is an operation for setting the traveling power supply to ON, and is, for example, an operation of pressing the start button 6 while depressing the brake pedal. Specific content of the start operation can be appropriately changed.

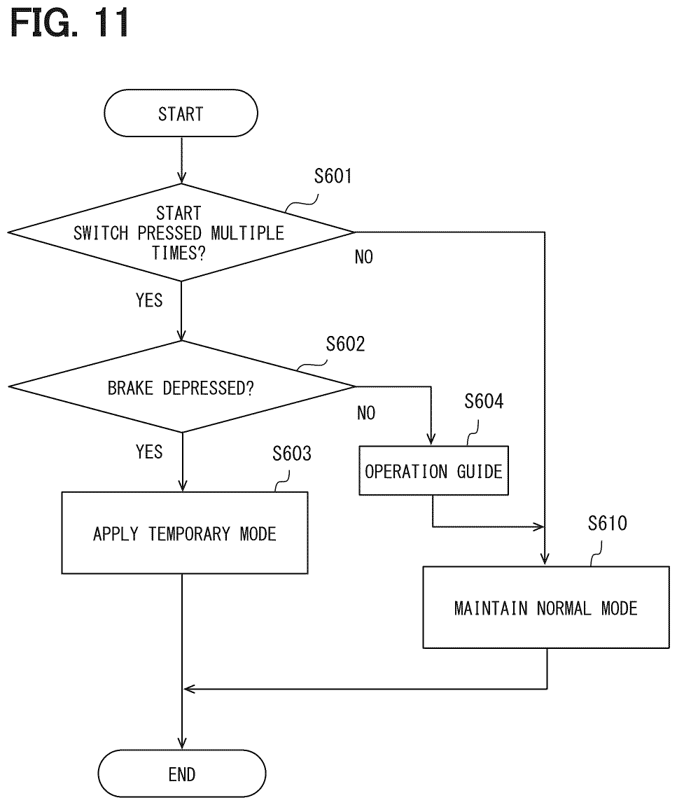

FIG. 11 is a flowchart illustrating an example of a processing sequence according to a modification. The processing flow can be performed in parallel with or in combination with the above-described various processes. As illustrated in FIG. 11, when it is detected that the start button 6 is pressed multiple times in the normal mode (S601: YES), the processor 41 determines whether the brake pedal is depressed. When the start button 6 is pressed a predetermined number of times in a state where the brake pedal is depressed (S602: YES), the processor 41 shifts to the temporary mode (S603).

When it is detected that the start button 6 is pressed multiple times in a state where the brake pedal is not depressed (S602: NO), the processor 41 displays an operation guide screen on the display 15 (S604). The operation guide screen is a screen showing a predetermined start operation. For example, in S604, the processor 41 causes the display 15 to display an image indicating that the start button 6 is pressed while the brake pedal is depressed.

When no failure is detected in the BLE communication device 7p and it is not detected that the start button 6 is pressed multiple times, the normal mode is maintained (S610). Further, even in the case where the start button 6 is pressed multiple times, the normal mode is also maintained when it is detected that the foot brake is forgotten to be depressed.

The above configuration is based on the following idea. That is, a high-frequency radio wave used by the BLE or the like has strong straightness, and thus is less likely to sneak. The high-frequency radio wave is easily attenuated by the human body. Therefore, depending on the mode of carrying the portable device 2 or the place where the portable device 2 is placed, the reception state of the device signal at the BLE communication device 7p may not satisfy the normal area determination condition. That is, even if no failure occurs in the BLE communication device 7p, the normal area determination condition may not be satisfied, and as a result, even if the user performs an appropriate start operation, the traveling power supply may not be switched on.

The present modification is created by focusing on the above problem, and according to a mode in which the operating mode is shifted to the temporary mode when the specific action of the user is detected, even when the BLE communication device 7p cannot communicate with the portable device 2 well due to the radio wave environment, the traveling power supply can be set to ON. This is because in the temporary mode, a determination material (communication device)/algorithm different from that in the normal mode is applied for the instruction of the driving source. The high-frequency radio wave in the present disclosure is not limited to a radio wave of 1 GHz or more, and includes a radio wave of a sub-gigahertz band such as 920 MHz.

### Modification (2)

An upper limit may be set for the number of times the temporary mode can be applied. This is because the temporary mode is only an emergency measure for enabling traveling to a repair shop or the like. Further, when the temporary mode can be performed without limitation, there is a high possibility that the repair of the BLE communication device 7p is put off. In order to prompt the user to quickly take measures such as repair in response to the failure of the BLE communication device 7p, it is preferable that a temporary start permission number, which is the number of times the traveling power supply can be switched on in the temporary mode, is limited to several times, for example, three times.

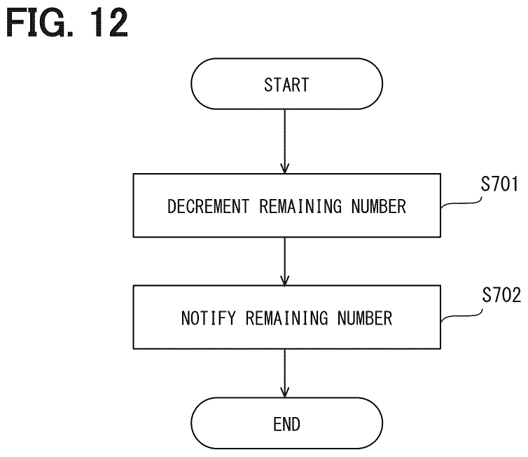

For example, as illustrated in FIG. 12, based on the shift from the normal mode to the temporary mode, the processor 41 decreases a temporary start remaining number, which is the remaining number of times that the traveling power supply can be switched on in the temporary mode, by one (S701). The temporary start remaining number may be updated not at the time of shift to the temporary mode but at a timing at which the traveling power supply is actually set to ON in the temporary mode. Then, when the operating mode is switched to the temporary mode, the processor 41 performs a process for notifying the user of the temporary start remaining number. The temporary start remaining number can be included in a message to be displayed/output by voice, as the failure notification process described above, for example. The temporary start remaining number may be transmitted to a vehicle coordination device via a server or the like. The temporary start remaining number may be managed by being distinguished for each user in the storage 43 or the like. Based on the confirmation that the BLE communication device 7p is operating normally, the processor 41 returns the temporary start remaining number for each user to any initial value of 1 or greater such as 3 and 5.

The processor 41 may confirm the temporary start remaining number when a failure is detected in the BLE communication device 7p, and shift to the temporary mode on condition that the temporary start remaining number is 1 or more. The processor 41 may not shift to the temporary mode when the temporary start remaining number is 0.

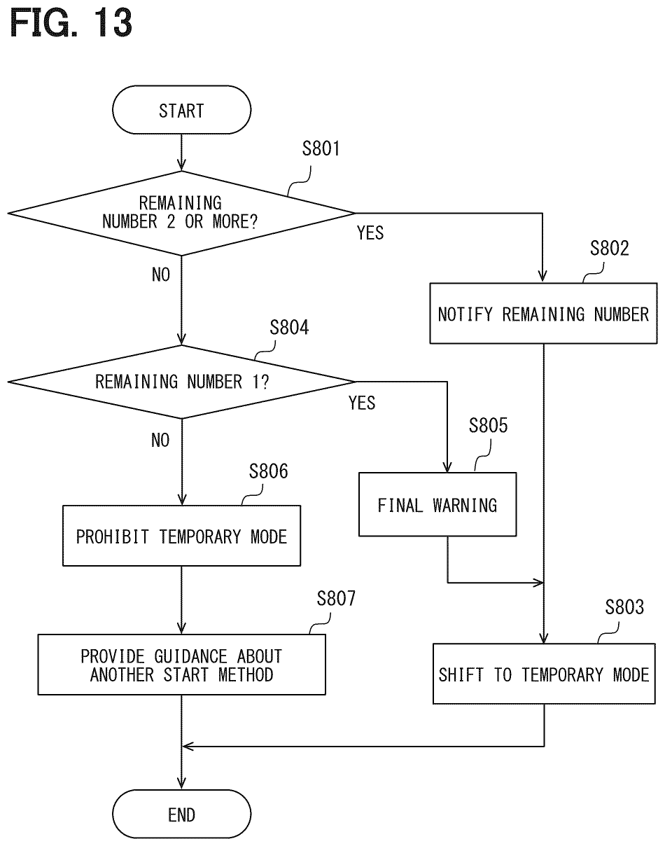

The processor 41 may change a behavior according to the temporary start remaining number when a failure is detected in the BLE communication device 7p. For example, as illustrated in FIG. 13, when a failure of the BLE communication device 7p is detected, the processor 41 confirms the temporary start remaining number. When the temporary start remaining number is two or more (S801: YES), the remaining number is notified in a predetermined mode (S802). Then, the processor 41 shifts to the temporary mode in S803.

When a failure of the BLE communication device 7p is detected and the temporary start remaining number is 1 (S804: YES), the processor 41 performs a final warning process (S805) and then shifts to the temporary mode (S803). The final warning process is a process of notifying the user, in a highlighted form than a normal notification form, that the traveling power supply cannot be turned on in the next temporary mode. The normal notification form related to the temporary start remaining number indicates a notification form in a case where the remaining number is two or more, such as in S802.

When the temporary start remaining number is 0 (S804: NO), the processor 41 stops the shift to the temporary mode (S806). Then, the processor 41 provides guidance about another start method. For example, when the vehicle Hv can be started with a mechanical key, the processor 41 displays, on the display 15, an image indicating a start method using the mechanical key. When the vehicle Hv can be started by NFC communication with the portable device 2, the processor 41 may display, on the display 15, an image indicating a start method using the NFC communication. In addition, when the remaining number is 0, the processor 41 may display, as a guide image, the telephone number of a road service. Here, the road service refers to a service in which a work staff comes to the side of the vehicle Hv and performs tow car movement to a maintenance factory or performs repair on the spot.

### Modification (3)

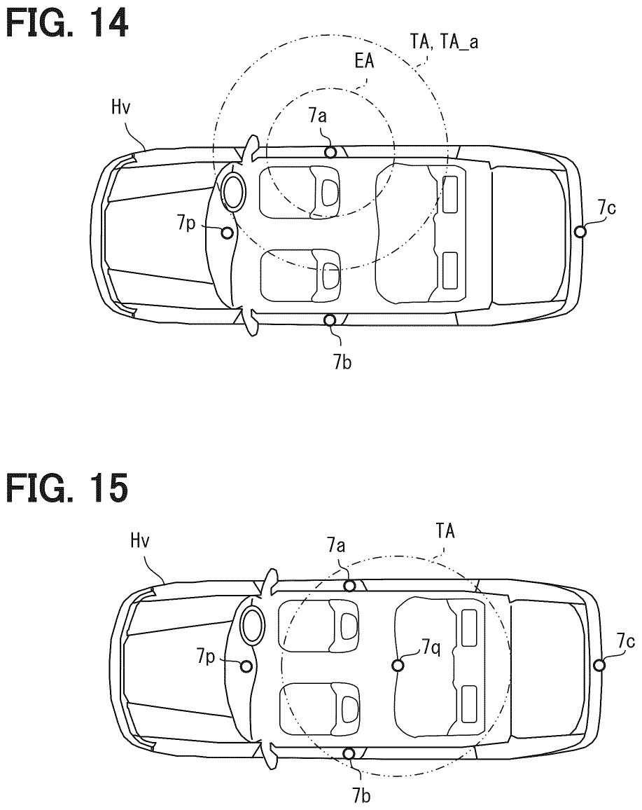

In the embodiment described above, both the BLE communication devices 7a and 7b are used as the substitute devices, and a combination of the BLE communication devices 7 to be used as the substitute devices is not limited thereto. The substitute device may be only the BLE communication device 7a as illustrated in FIG. 14. In other words, the substitute device may be only the BLE communication device 7 forming the locking and unlocking area EA of the driver's seat.

Further, as tentatively illustrated in FIG. 15, when the in-vehicle system 1 includes a BLE communication device 7q as an in-cabin unit other than the BLE communication device 7p, the BLE communication device 7q may be adopted as a substitute device. The BLE communication device 7q is, for example, an in-cabin unit disposed on a seating surface or near a foot of a rear seat. In order to distinguish from the BLE communication device 7p serving as a front in-cabin unit, the BLE communication device 7q can be referred to as a rear in-cabin unit. A two-dot chain line in FIG. 15 conceptually indicates the temporary threshold excess area TA formed by the BLE communication device 7q. The BLE communication device 7q is the BLE communication device 7 for determining whether the portable device 2 is present in the vehicle in order to prevent the portable device 2 from being confined in the vehicle. The BLE communication device 7q is the BLE communication device 7 that is not used to determine whether the portable device 2 is present in the start area in the normal mode. Alternatively, the processor 41 may use, as a substitute device, the BLE communication device 7x serving as a gateway communication device.

### Modification (4)

In the above-described embodiment, the mode in which the start area is formed using only the BLE communication device 7p has been described, and the present disclosure is not limited thereto. The in-vehicle system 1 may form the start area SA using multiple in-cabin units. For example, the start area may be formed using the BLE communication devices 7p and 7q. In other words, in the normal mode, the processor 41 may determine whether the portable device 2 is present in the start area SA based on the reception states of the device signals at the BLE communication devices 7p and 7q. In this case, the normal mode is an operating mode of a case where it is confirmed that both the BLE communication devices 7p and 7q are operating normally. The temporary mode is an operating mode of a case where a failure is detected in one or both of the BLE communication devices 7p and 7q.

### Modification (5)

The processor 41 determines whether the portable device 2 is present in a start area by using not only a reception state at the BLE communication device 7p but also a reception state at an outside-cabin unit. For example, in the normal mode, when reception strength at the BLE communication device 7p is equal to or greater than a start area determination value and both reception strength at the BLE communication devices 7a and 7b is less than a predetermined threshold, the processor 41 may determine that the portable device 2 is present in the start area SA.

### Modification (6)

In the above-described embodiment, the configuration in which a device position is determined using the reception strength at the BLE communication device 7p has been described, and a material (index) for determining the device position is not limited thereto. The processor 41 may determine the device position based on a time-of-flight (ToF) correlation value generated by causing a specific BLE communication device 7 to perform distance measurement communication with the portable device 2. The ToF correlation value is a parameter indicating a time of flight of a signal transmitted from the portable device 2 until the signal is received by the BLE communication device 7. The ToF correlation value is a parameter different from the reception strength. Specifically, the ToF correlation value is RTT or a two-frequency phase difference. The distance measurement communication can be referred to as communication for measuring the RTT or the two-frequency phase difference. The RTT and the two-frequency phase difference correspond to a measurement result of the distance to the portable device 2, and thus can be referred to as a measured distance value.

The RTT with the portable device 2 as a communication partner is measured as a time from when the BLE communication device 7 transmits a response request signal to the portable device 2 to when the BLE communication device 7 receives a response signal from the portable device 2. The processor 41 may use, as the RTT, a value obtained by performing a predetermined correction process such as subtracting, from an elapsed time from actual transmission to reception of a signal, an assumed value of a response processing time generated in the portable device 2.

The two-frequency phase difference is a parameter specified by the BLE communication device 7 and the portable device 2 transmitting and receiving a continuous wave (CW) signal, and is a difference of a transmission and reception phase difference observed at each of two frequencies. The transmission and reception phase difference at a certain frequency corresponds to a phase difference between the CW signal of a target frequency transmitted to a target and the CW signal of the target frequency returned from the target.

The transmission and reception phase difference may be simply referred to as a phase angle. The transmission and reception phase difference can be specified by, for example, causing the BLE communication device 7 and the portable device 2 to transmit and receive a CW signal to and from each other to each detect a phase difference between a transmission signal and a received signal, and obtaining an average value of the phase differences observed by both communication devices. The processor 41 may adopt a reception phase of the CW signal transmitted from the portable device 2 as the transmission and reception phase difference without change on an assumption that initial phases or local oscillators are synchronized between devices. The initial phase or local oscillator synchronization between the devices can be implemented by, for example, transmitting a predetermined synchronization signal. The two-frequency phase difference corresponds to a displacement amount of the transmission and reception phase difference due to a change in frequency.

Each BLE communication device 7 performs the distance measurement communication with the portable device 2 based on an instruction from the processor 41, generates a ToF correlation value, and reports the ToF correlation value to the processor 41. The processor 41 calculates a distance from the BLE communication device 7 to the portable device 2 based on the ToF correlation value observed by a certain BLE communication device 7. The generation (arithmetic operation) of the ToF correlation value may be performed by the processor 41. A functional arrangement can be appropriately changed.

In the normal mode, the processor 41 in the present modification causes the BLE communication device 7p to perform the distance measurement communication with the portable device 2, thereby calculating the distance from the BLE communication device 7p to the portable device 2. When a measured distance value starting from the BLE communication device 7p is less than a predetermined start area determination value, the processor 41 determines that the portable device 2 is in the start area.

On the other hand, in the temporary mode, the processor 41 causes each of the BLE communication devices 7a and 7b to perform the distance measurement communication with the portable device 2, thereby calculating distances from the BLE communication devices 7a and 7b to the portable device 2. That is, in the temporary mode, the processor 41 acquires a measured distance value from at least one substitute device to the portable device 2 by causing the substitute device to perform the distance measurement communication. Then, when the measured distance value starting from each substitute device is less than a predetermined temporary start area determination value, the portable device 2 is determined to be in the start area.

The processor 41 may determine whether the portable device 2 is present in a start permitting area, and further whether normal or temporary area determination condition is satisfied, by using the measured value and the reception strength in combination. For example, in the normal mode, when a measured value starting from the BLE communication device 7p is less than a first predetermined value and reception strength is equal to or greater than a second predetermined value, the processor 41 determines that the portable device 2 is in the start area. On the other hand, in the temporary mode, when a measured value starting from a predetermined substitute device is less than a third predetermined value and reception strength at the substitute device is equal to or greater than a fourth predetermined value, the processor 41 may determine that the portable device 2 is in the start area. The first predetermined value related to the measured distance value may be, for example, 0.5 m, and the third predetermined value may be set to 1.2 m. The fourth predetermined value related to the reception strength may be set to a value smaller than the second predetermined value by about 15 dB.

As data indicating the reception state of the device signal at the BLE communication device 7, an arrival direction of a radio wave or the like can be adopted in addition to the reception strength and the Tof correlation value (measured distance value). For example, the processor 41 may determine the device position by using both an arrival direction angle of the device signal and the measured distance value or the reception strength.

### Modification (7)

An arrangement number and an arrangement mode of the BLE communication device 7 of the present disclosure are merely examples and can be appropriately changed. The BLE communication device 7a and the BLE communication device 7b may be disposed on an outer side surface of a B pillar or a C pillar. The B pillar provided in the vehicle Hv can be divided into a door-side B pillar provided in a door module and a vehicle-body-side B pillar serving as a column or frame including a roof portion of a vehicle body. The door-side B pillar corresponds to a portion of a front door or a rear door that is in contact with a vehicle-body-side pillar. An outside-cabin unit can be disposed at a portion of the door-side B pillar adjacent to a side window, that is, a portion above a lower end portion of the side window.

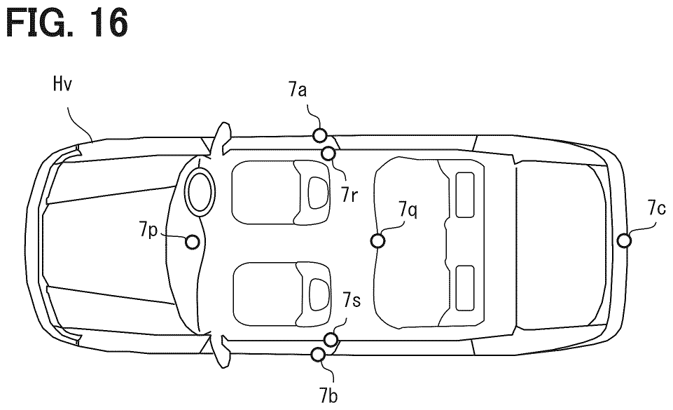

Multiple in-cabin units may be provided. For example, as illustrated in FIG. 16, the in-vehicle system 1 may include BLE communication devices 7p, 7s, 7s, and 7r as in-cabin units. The BLE communication device 7s is the BLE communication device 7 disposed on a right side surface in the vehicle, for example, an in-cabin side surface of a right-side B pillar or on an in-cabin side surface of a driver seat door. The BLE communication device 7r is the BLE communication device 7 disposed on a left side surface in the vehicle, for example, an in-cabin side surface of a left-side B pillar or on an in-cabin side surface of a front passenger seat door. As mounting positions of the BLE communication devices 7s and 7r, it is possible to adopt a position which is lower than the lower end portion of the side window by 0.1 m or more on an in-cabin surface of the vehicle-body-side B pillar.

### Modification (8)

The processor 41 may specify position coordinates with respect to the vehicle Hv by combining measured distance values in multiple BLE communication devices 7 and mounting positions of the BLE communication devices 7 in the vehicle Hv, and may determine whether the portable device 2 is present in a start area based on the position coordinates. Position coordinates of the portable device 2 can be expressed by a vehicle coordinate system or the like. The position coordinates of the portable device 2 can be calculated based on the principle of triangulation or trilateration. In the present disclosure, a process of calculating device position coordinates is also referred to as a detailed position estimation process.

For example, when no failure is detected in any of the BLE communication devices 7p, 7q, 7r, and 7s that are in-cabin units, the processor 41 operates in the normal mode. That is, the processor 41 combines measurement results of the BLE communication devices 7p, 7q, 7r, and 7s to calculate the position coordinates of the portable device 2 in the vehicle. Then, when the calculated device position coordinates belong to the start area, the processor 41 determines that the portable device 2 is present in the start area. The configuration corresponds to a configuration in which the device position coordinates calculated based on the measured distance values of the multiple in-cabin units being within the start area is adopted as a normal area determination condition.

On the other hand, the processor 41 sets the temporary mode when a failure is detected in any of the BLE communication devices 7p, 7q, 7r, and 7s, and determines that the portable device 2 is present in the start area when reception strength at the in-cabin unit in which no failure is detected is equal to or greater than a predetermined value. The configuration corresponds to a configuration in which the reception strength at any of the multiple in-cabin units being equal to or greater than a start area determination value is adopted as a temporary area determination condition. In the processor 41, the temporary area determination condition in the temporary mode may be presence of an in-cabin unit whose measured distance value is less than a predetermined value, instead of or in parallel with presence of an in-cabin unit whose reception strength is equal to or greater than a predetermined value.

### APPENDIX

The device, the system, and the method described in the present disclosure may be implemented by a dedicated computer constituting a processor that is programmed to execute one or more functions implemented by a computer program. The device and the method described in the present disclosure may be implemented using a dedicated hardware logic circuit. Further, the device and the method described in the present disclosure may be implemented by one or more dedicated computers implemented by a combination of a processor that executes a computer program and one or more hardware logic circuits. For example, some or all of the functions of the processor 41 may be implemented as hardware. An aspect in which a certain function is implemented as hardware includes an aspect in which a certain function is implemented using one or more ICs or the like. As the processor (arithmetic core), a CPU, an MPU, a GPU, a data flow processor (DFP), or the like can be adopted. Some or all of the functions of the processor 41 may be implemented by combining multiple types of arithmetic processing devices. Some or all of the functions of the processor 41 may be implemented using a system-on chip (SoC), an FPGA, an ASIC, or the like. The FPGA is an abbreviation for Field Programmable Gate Array. The ASIC is an abbreviation for Application Specific Integrated Circuit. The computer program is stored in a computer-readable non-transitionary tangible recording medium (non-transitory tangible storage medium) as an instruction executed by the computer. As the storage medium of the computer program (control program), a hard disk drive (HDD), a solid state drive (SSD), a flash memory, or the like can be adopted.

What is claimed is:

1. A vehicle control device to be connected to a plurality of communication devices that are configured to perform radio communication with a portable device carried by a user of a vehicle by using a same communication band, the plurality of communication devices including a first communication device that is a specific one of the communication devices installed in the vehicle and a second communication device that is a specific one of the communication devices other than the first communication device, the vehicle control device comprising:
a communication control unit configured to
control the plurality of communication devices and
acquire data indicating a reception state of a radio signal from the portable device at the plurality of communication devices;
a diagnostic unit configured to detect a failure of the first communication device based on an input signal from the first communication device or based on a fact that no signal is received from the first communication device; and
a vehicle control unit configured to switch a traveling power supply between on and off, wherein
when the diagnostic unit detects no failure of the first communication device, the vehicle control unit is configured to permit the traveling power supply to be switched on based on a fact that data indicating a reception state of a signal from the portable device at the first communication device satisfies a specific normal area determination condition, and
when the diagnostic unit detects a failure of the first communication device, the vehicle control unit is configured to permit the traveling power supply to be switched on based on a fact that data indicating the reception state of the signal from the portable device at the second communication device satisfies a predetermined temporary area determination condition different from the normal area determination condition.

2. The vehicle control device according to claim 1, further comprising:
a position determination unit configured to determine a position of the portable device with respect to the vehicle based on the reception state from the portable device at the first communication device or the second communication device, wherein
an operating mode related to on-off control of the traveling power supply includes a normal mode to be applied when no failure is detected in the first communication device and a temporary mode to be applied when a failure is detected in the first communication device,
the vehicle control unit is configured to switch on the traveling power supply on condition that the position determination unit determines that the portable device is present in a start area in a vehicle cabin,
in a case where the normal mode is applied, the position determination unit is configured to determine that the portable device is present in the start area when a communication state at the first communication device satisfies the normal area determination condition, and
in a case where the temporary mode is applied, the position determination unit is configured to determine that the portable device is present in the start area when the communication state at the second communication device satisfies the temporary area determination condition.

3. The vehicle control device according to claim 2, wherein
the second communication device is a locking and unlocking area forming device configured to form, outside the vehicle cabin, an unlocking area that is an area for unlocking a door, and
in the temporary mode, the position determination unit is configured to determine that the portable device is present in the start area when reception strength at the locking and unlocking area forming device is equal to or greater than a predetermined value.

4. The vehicle control device according to claim 2, wherein
the vehicle control device is to be connected to the second communication device which includes a plurality of second communication devices, wherein
in the temporary mode, the position determination unit is configured to determine that the portable device is present in the start area by combining communication states with the portable device at the plurality of second communication devices.

5. The vehicle control device according to claim 2, further comprising:
a radio authentication unit configured to perform a radio authentication process to determine validity of the user by radio communication with the portable device; and
an additional authentication unit configured to perform an additional authentication process to determine validity of the user by using biometric information or a passcode, wherein
in the normal mode, the traveling power supply is permitted to be switched on when the portable device is present in the start area and when the radio authentication process is successful, and
in the temporary mode, the traveling power supply is permitted to be switched on when the portable device is present in the start area, when the radio authentication process is successful, and when the additional authentication process is successful.

6. The vehicle control device according to claim 2, further comprising:
at least one processor, wherein
the at least one processor is configured to
determine, based on an input signal indicating whether a start button, which is a button configured to switch on the traveling power supply, is pressed, whether the user has pressed the start button a predetermined number of times or more within a predetermined time, and
switch the operating mode to the temporary mode based on detection that the user has pressed the start button the predetermined number of times or more within the predetermined time.

7. The vehicle control device according to claim 2, further comprising:
at least one processor, wherein
when the temporary mode is applied, the at least one processor is configured to display, on an in-vehicle display, an image showing that a failure has occurred in the first communication device.

8. The vehicle control device according to claim 2, further comprising:
at least one processor, wherein
when the temporary mode is applied, the at least one processor is configured to transmit a message indicating a shift to the temporary mode to a device, a mail address, or a telephone number registered in advance.

9. The vehicle control device according to claim 2, further comprising:
at least one processor, wherein
an upper limit is set for a temporary start permission number that is the number of times by which the traveling power supply is able to be set to on in the temporary mode, and
in a case where a temporary start remaining number that is a remaining number of times by which the traveling power supply is able to be set to on in the temporary mode is 0, the at least one processor is configured not to shift to the temporary mode even when a failure is detected in the first communication device.

10. The vehicle control device according to claim 9, wherein
the at least one processor is configured to
update the temporary start remaining number every time the traveling power supply is set to on in the temporary mode, and
notify the user of the temporary start remaining number every time the temporary mode is applied.

11. A vehicle control device to be connected to a plurality of communication devices that are configured to perform radio communication with a portable device carried by a user of a vehicle by using a same communication band, the plurality of communication devices including a first communication device that is a specific one of the communication devices installed in the vehicle and a second communication device that is a specific one of the communication devices other than the first communication device, the vehicle control device comprising:
a communication control unit configured to
control the plurality of communication devices and
acquire data indicating a reception state of a radio signal from the portable device at the plurality of communication devices;
a diagnostic unit configured to detect a failure of the first communication device based on an input signal from the first communication device or based on a fact that no signal is received from the first communication device; and
a position determination unit configured to determine a position of the portable device with respect to the vehicle based on a reception state from the portable device at the first communication device or the second communication device, wherein
in a case where the diagnostic unit detects no failure of the first communication device, the position determination unit is configured to determine that the portable device is present in a start area in a vehicle cabin when data indicating a reception state of a signal from the portable device at the first communication device satisfies a specific normal area determination condition, and
in a case where the diagnostic unit detects a failure of the first communication device, the position determination unit is configured to determine that the portable device is present in the start area when data indicating the reception state of the signal from the portable device at the second communication device satisfies a predetermined temporary area determination condition different from the normal area determination condition.

12. A vehicle control method for switching on a traveling power supply of a vehicle, which is to be executed by at least one processor, the vehicle control method comprising:
acquiring, from a first communication device configured to perform radio communication with a portable device carried by a user of the vehicle, data indicating a reception state of a signal from the portable device;
acquiring, from a second communication device, data indicating the reception state of the signal from the portable device, the second communication device being arranged at a position different from the first communication device and being configured to perform radio communication using a communication band same as the first communication device;
detecting a failure of the first communication device based on an input signal from the first communication device or based on a fact that no signal is received from the first communication device;
permitting the traveling power supply to be switched on based on a fact that the reception state of the signal from the portable device at the first communication device satisfies a specific normal area determination condition when no failure of the first communication device is detected; and
permitting the traveling power supply to be switched on based on a fact that the reception state of the signal from the portable device at the second communication device satisfies a predetermined temporary area determination condition different from the normal area determination condition when a failure of the first communication device is detected.

13. A non-transitory computer-readable storage medium storing instructions configured to, when executed by at least one processor, cause the at least one processor to:
acquire, from a first communication device configured to perform radio communication with a portable device carried by a user of a vehicle, data indicating a reception state of a signal from the portable device;
acquire, from a second communication device, data indicating the reception state of the signal from the portable device, the second communication device being arranged at a position different from the first communication device and being configured to perform radio communication using a communication band same as the first communication device;
detect a failure of the first communication device based on an input signal from the first communication device or based on a fact that no signal is received from the first communication device;
permit the traveling power supply to be switched on based on a fact that the reception state of the signal from the portable device at the first communication device satisfies a specific normal area determination condition when no failure of the first communication device is detected; and
permit the traveling power supply to be switched on based on a fact that the reception state of the signal from the portable device at the second communication device satisfies a predetermined temporary area determination condition different from the normal area determination condition when a failure of the first communication device is detected.
